(19) United States
(12) Patent Application Publication
(10) Pub. No.: US 2023/0327068 A1
(43) Pub. Date: Oct. 12, 2023

(54) CONTINUOUS AND SEMI-CONTINUOUS METHODS OF ELECTRODE AND ELECTROCHEMICAL CELL PRODUCTION

(71) Applicant: 24M Technologies, Inc., Cambridge, MA (US)

(72) Inventors: Matthew R. TYLER, New York, NY (US); Sarah COLE, Somerville, MA (US); Glenn JORDAN, Harvard, MA (US); Hasan SIDDIQUI, Chelsea, MA (US); Raymond ZAGARS, Pensacola, FL (US)

(21) Appl. No.: 18/133,671

(22) Filed: Apr. 12, 2023

Related U.S. Application Data
(60) Provisional application No. 63/343,339, filed on May 18, 2022.
(60) Provisional application No. 63/329,994, filed on Apr. 12, 2022.

(51) Int. Cl. H01M 4/04

(52) U.S. Cl. CPC H01M 4/0404

(57) ABSTRACT

Embodiments described herein relate generally to systems and methods for continuously and/or semi-continuously manufacturing electrochemical cells with semi-solid electrodes. In some embodiments, a method can include mixing an active material, a conductive material, and an electrolyte to form a semi-solid electrode material. The method further includes drawing a vacuum on the semi-solid electrode material, compressing the semi-solid electrode material to form an electrode brick, and dispensing a portion of the electrode brick onto a current collector via a dispensation device to form an electrode. In some embodiments, the current collector is disposed on a pouch material. In some embodiments, the dispensation device includes a top blade for top edge control and two side plates for side edge control. In some embodiments, the method can further include conveying the electrode through the top blade and the two side plates to shape the electrode.

### CROSS REFERENCE TO RELATED APPLICATIONS

This application claims the benefit of U.S. Provisional Application No. 63/329,994, titled “Continuous and Semi-Continuous Methods of Electrode and Electrochemical Cell Production,” and filed Apr. 12, 2022, and U.S. Provisional Application No. 63/343,339, titled “Continuous and Semi-Continuous Methods of Electrode and Electrochemical Cell Production,” and filed May 18, 2022, the contents of each of which are incorporated herein by reference in their entireties.

### TECHNICAL FIELD

Embodiments described herein relate to systems and methods for producing electrochemical cells with at least one semi-solid electrode.

### BACKGROUND

Embodiments described herein relate generally to systems and methods for continuously and/or semi-continuously manufacturing electrochemical cells with semi-solid electrodes. Battery manufacturing methods typically include coating a conductive substrate (i.e., a current collector) with a slurry that includes an active material, a conductive additive, and a binding agent dissolved or dispersed in a solvent. After the slurry is coated onto the metallic substrate, the slurry is dried (e.g., by evaporating the solvent) and calendered to a specified thickness. The manufacture of battery electrodes can also commonly include material mixing, casting, calendering, drying, slitting, and working (bending, rolling, etc.) according to the battery architecture being built. Because the electrode is manipulated during assembly, and to ensure conductive networks are in place, all components are compressed into a cohesive assembly, for example, by use of the binding agent. However, binding agents themselves occupy space, can add processing complexity, and can impede ionic and electronic conductivity. Production of semi-solid electrodes with little or no binder can address some of these issues. However, several issues can arise during the production of semi-solid electrodes

First, edge control of semi-solid electrodes can be difficult. Stencils and masks often shape the edges of semi-solid electrodes. Stencils and masks are often inefficient and can lead to less defined edges (i.e., crumbling of edges). Loss of electrolyte and/or electrolyte solvent via evaporation can occur during processing, leading to inefficient battery performance. Small batch processes of electrode production can lead to various concentration gradients in the electrodes or lack of homogeneity. Additionally, cutting of current collectors via mechanical means can also lead to inefficiencies, as worn tooling has to be replaced frequently.

### SUMMARY

Embodiments described herein relate generally to systems and methods for continuously and/or semi-continuously manufacturing electrochemical cells with semi-solid electrodes. In some embodiments, a method can include mixing an active material, a conductive material, and an electrolyte to form a semi-solid electrode material. The method further includes drawing a vacuum on the semi-solid electrode material, compressing the semi-solid electrode material to form an electrode brick, and dispensing a portion of the electrode brick onto a current collector via a dispensation device to form an electrode. In some embodiments, the current collector is disposed on a pouch material. In some embodiments, the dispensation device includes a top blade for thickness control and two side plates for side edge control. In some embodiments, the method can further include conveying the electrode through the top blade and the two side plates to shape the electrode. In some embodiments, the dispensation device can apply a downward force onto the pouch, such that the two side plates form a seal with the pouch.

### BRIEF DESCRIPTION OF THE DRAWINGS

FIG. 1 is a schematic diagram of a method of semi-continuous or continuous manufacturing of a semi-solid electrode, according to an embodiment.

FIG. 2 is a schematic diagram of a system for semi-continuous or continuous manufacture of a semi-solid electrode, according to an embodiment.

FIG. 3 is an illustration of a gravity dryer, according to an embodiment.

FIG. 4 is an illustration of a compressor, according to an embodiment.

FIG. 5 is an illustration of a cartridge with a shaping device, according to an embodiment.

FIG. 6 is an illustration of a laser cutting device, according to an embodiment.

FIG. 7 is an illustration of a wetting device and a tunnel, according to an embodiment.

FIGS. 8A-8B are illustrations of a sealing device, according to an embodiment.

FIG. 9 is an illustration of a gravity dryer, according to an embodiment.

FIGS. 10A-10B are illustrations of components of a brick-forming system, according to an embodiment.

FIGS. 11A-11F are illustrations of a compressor, according to an embodiment.

FIGS. 12A-12E are illustrations of an extrusion system, according to an embodiment.

FIG. 13 shows an adjoining system with a set of rotating drums for assembly of an electrochemical cell, according to an embodiment.

FIGS. 14A-14C show a cartridge, and various components thereof, according to an embodiment.

FIG. 15 is an illustration of a densification station, according to an embodiment.

FIGS. 16A-16C are illustrations of a conveyor with a web-steering system incorporated therein, according to an embodiment.

FIGS. 17A-17D are illustrations of a pouch sealer, according to an embodiment.

FIG. 18 is an illustration of a web steering apparatus, according to an embodiment.

FIG. 19 is an illustration of a system for continuous or semi-continuous manufacture of electrochemical cells including semisolid electrodes, according to an embodiment.

FIG. 20 is an illustration of a portion of the system of FIG. 19 indicated by the arrow A in FIG. 19 that includes a cathode casting station, according to an embodiment.

FIG. 21 is an illustration showing a top view of a web alignment assembly that may be included in the system of FIG. 19, according to an embodiment.

FIG. 22 is another view of the web alignment assembly of FIG. 21.

FIG. 23 is a side view of the web alignment assembly of FIG. 21.

FIG. 24 is a side view of a portion of the web alignment assembly of FIG. 23 indicated by the arrow B in FIG. 23.

FIG. 25 is a side cross-section view of a portion of the web alignment assembly taken along the line C-C in FIG. 24.

### DETAILED DESCRIPTION

Embodiments described herein relate generally to systems and methods for continuously and/or semi-continuously manufacturing electrochemical cells with semi-solid electrodes. In some embodiments, an electrode brick can be formed from an active material, a conductive material, and an electrolyte. In some embodiments, the brick can be substantially large, such that more than about 100 semi-solid electrodes can be formed from the material of a single electrode brick. In some embodiments, the brick can be formed of densified semi-solid electrode material. Examples of densified semi-solid electrodes and methods of manufacturing the same are described in U.S. Patent Publication No. 2021/0226192, entitled “Apparatuses and Processes for Forming a Semi-Solid Electrode Having High Active Solids Loading and Electrochemical Cells Including the Same,” filed Jan. 21, 2020 (the '192 publication), the entire disclosure of which is hereby incorporated by reference. In some embodiments, the electrode brick can be infused with electrolyte. Examples of infusion processes are described in U.S. Pat. No. 11,005,087, entitled “Systems and Methods for Infusion Mixing a Slurry-Based Electrode,” filed Jan. 17, 2017 (the '087 patent), the entire disclosure of which is hereby incorporated by reference. In some embodiments, production processes described herein can include any of the process steps described in U.S. Patent Publication No. 2022/0115710 (“the '710 publication”), filed Dec. 12, 2021, and titled “Methods of Continuous and Semi-Continuous Production of Electrochemical Cells,” the disclosure of which is hereby incorporated by reference in its entirety.

In some embodiments, pre-processing treatments (e.g., drying) can be applied to the active material and the conductive material. After formation of the electrode brick, the electrode brick can be disposed into a cartridge. In some embodiments, the brick can have a high level of homogeneity. From the cartridge, a portion of the electrode brick is dispensed onto a current collector to form a semi-solid electrode. In some embodiments, the semi-solid electrode can then be shaped by both a top blade and side plates. In some embodiments, the electrode can be wetted by a solvent (e.g., an electrolyte or an electrolyte solvent). In some embodiments, the electrode can be a first electrode, and can be adjoined to a second electrode with a separator disposed therebetween to form an electrochemical cell. In some embodiments, pouch material on the outside of the electrochemical cell can be sealed in a single step. Other possible processing steps are described in U.S. Patent Publication No. 2020/0014025, entitled “Continuous and Semi-Continuous Methods of Semi-Solid Electrode and Battery Manufacturing,” filed Jul. 9, 2019 (the '025 publication), the entire disclosure of which is hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “z-direction” generally means the third direction where longitudinal and transverse are the first and second directions, unless indicated otherwise. In other words, the z-direction refers to the depth or thickness of a feature as opposed to length and width.

As used herein, the term “about” and “approximately” generally mean plus or minus 10% of the value stated, e.g., about 250 μm would include 225 μm to 275 μm, about 1,000 μm would include 900 μm to 1,100 μm.

As used herein, the term “semi-solid” refers to a material that is a mixture of liquid and solid phases, for example, such as particle suspension, colloidal suspension, emulsion, gel, or micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

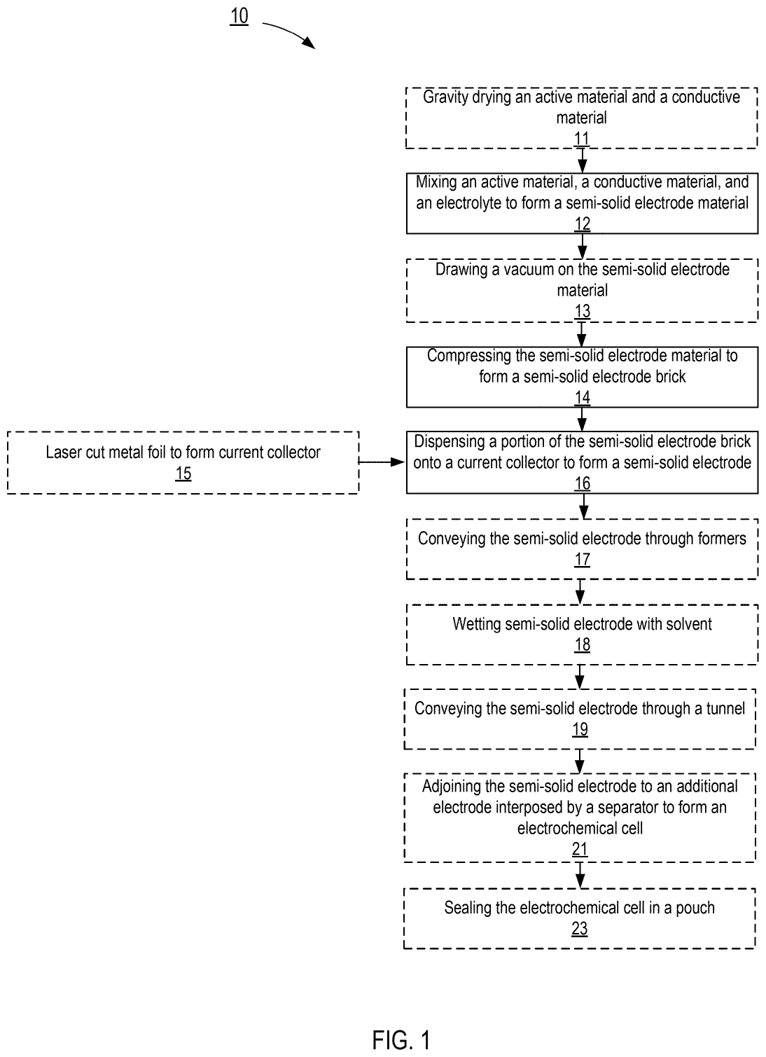

FIG. 1 is a schematic diagram of a method 10 of semi-continuous or continuous manufacturing of a semi-solid electrode, according to an embodiment. As shown, the method 10 optionally includes gravity drying an active material and a conductive material at step 11. The method 10 then includes mixing an active material, a conductive material, and an electrolyte to form a semi-solid electrode material at step 12. The method 10 optionally includes drawing a vacuum on the semi-solid electrode material at step 13. The method 10 further includes compressing the semi-solid electrode material to form a semi-solid electrode brick at step 14 and dispensing a portion of the semi-solid electrode brick onto a current collector to form a semi-solid electrode at step 16. The method 10 then optionally includes conveying the electrode through formers at step 17, wetting the semi-solid electrode with a solvent at step 18, conveying the semi-solid electrode through a tunnel at step 19, adjoining the semi-solid electrode to an additional electrode interposed by a separator to form an electrochemical cell at step 21, and sealing the electrochemical cell in a pouch at step 23.

At step 11, a drying step can be employed to remove excess moisture from either of the materials used for manufacturing the semi-solid electrode. In some embodiments, a powder is subjected to a drying step. In some embodiments, the powder can include active material. In some embodiments, the powder can include conductive material. In some embodiments, the powder can include both active material and conductive material. In some embodiments, step 11 can include a gravity drying step. In some embodiments, the gravity drying can include allowing the powder to fall (i.e., via gravity) through a drying vessel. In some embodiments, a drying gas can flow through the drying vessel while the powder is falling vertically through the drying vessel. The use of a gravity drying process can be more effective and efficient than a simple drying oven or a drying oven with a conveyor. As one advantage, the powder can move in three dimensions when falling through a vessel. In other words, the powder moves downward with gravity, can spread out front-to-back, and can spread out left-to-right. This is in contrast to a simple drying oven where the powder does not move, of a conveyor, in which the powder simply moves in one dimension along the conveyor. This freedom of motion can help the powder spread out and have more surface area exposed to the drying gas. Also, the use of gravity to move the powder can be more energy efficient than the use of a pneumatic stream. Additionally, the drying gas can flow perpendicular or counter-current to the movement of the powder, thus increasing the efficiency of heat exchange (i.e., counter-current heat exchange is more effective than parallel flow heat exchange). In some embodiments, the drying gas can include air, argon, helium, nitrogen, or any non-reactive gas or combinations thereof. In some embodiments, the drying gas can have a moisture content of less than about 1 ppm, less than about 0.9 ppm, less than about 0.8 ppm, less than about 0.7 ppm, less than about 0.6 ppm, less than about 0.5 ppm, less than about 0.4 ppm, less than about 0.3 ppm, less than about 0.2 ppm, less than about 0.1 ppm, less than about 0.09 ppm, less than about 0.08 ppm, less than about 0.07 ppm, less than about 0.06 ppm, less than about 0.05 ppm, less than about 0.04 ppm, less than about 0.03 ppm, less than about 0.02 ppm, or less than about 0.01 ppm, inclusive of all values and ranges therebetween.

In some embodiments, step 11 can occur at ambient temperature. In some embodiments, step 11 can include the application of heat. In some embodiments, the drying vessel in step 11 can be maintained at a temperature of at least about 25° C., at least about 30° C., at least about 35° C., at least about 40° C., at least about 45° C., at least about 50° C., at least about 55° C., at least about 60° C., at least about 65° C., at least about 70° C., at least about 75° C., at least about 80° C., at least about 85° C., at least about 90° C., or at least about 95° C. In some embodiments, the drying vessel in step 11 can be maintained at a temperature of no more than about 100° C., no more than about 95° C., no more than about 90° C., no more than about 85° C., no more than about 80° C., no more than about 75° C., no more than about 70° C., no more than about 65° C., no more than about 60° C., no more than about 55° C., no more than about 50° C., no more than about 45° C., no more than about 40° C., no more than about 35° C., or no more than about 30° C. Combinations of the above-referenced temperatures of the drying vessel in step 11 are also possible (e.g., at least about 25° C. and no more than about 100° C. or at least about 50° C. and no more than about 75° C.), inclusive of all values and ranges therebetween. In some embodiments, the drying vessel in step 11 can be maintained at a temperature of about 25° C., about 30° C., about 35° C., about 40° C., about 45° C., about 50° C., about 55° C., about 60° C., about 65° C., about 70° C., about 75° C., about 80° C., about 85° C., about 90° C., about 95° C., or about 100° C.

In some embodiments, the powder can have a moisture content of less than about 10 ppm, less than about 9 ppm, less than about 8 ppm, less than about 7 ppm, less than about 6 ppm, less than about 5 ppm, less than about 4 ppm, less than about 3 ppm, less than about 2 ppm, less than about 1 ppm, less than about 0.9 ppm, less than about 0.8 ppm, less than about 0.7 ppm, less than about 0.6 ppm, less than about 0.5 ppm, less than about 0.4 ppm, less than about 0.3 ppm, less than about 0.2 ppm, or less than about 0.1 ppm by weight after step 11, inclusive of all values and ranges therebetween.

At step 12, the active material, the conductive material, and an electrolyte are mixed together to form a semi-solid electrode material. In some embodiments, the active material, the conductive material, and the electrolyte are mixed without a binder. In some embodiments, the semi-solid electrode material can be binderless or substantially binderless. In some embodiments, the mixing can be via a continuous process. In some embodiments, the mixing can be in a continuous mixer. In some embodiments, the mixing can be in a twin-screw extruder. Further examples of mixing methods and compositions are described in U.S. Pat. No. 9,484,569, entitled “Electrochemical Slurry Compositions and Methods for Preparing the Same,” filed Mar. 15, 2013 (the '569 patent), the entire disclosure of which is hereby incorporated by reference in its entirety. In some embodiments, the electrolyte can be incorporated into the active material and the conductive material via an infusion process. In some embodiments, the infusion process can include drawing a vacuum. In some embodiments, the semi-solid electrode can be mixed substantially, such that the semi-solid electrode material has a high level of homogeneity. Further examples of infusion processes are described in the '087 patent. In some embodiments, electrochemical cells described herein can include separators with separator seals. Further examples of separators with separator seals are described in greater detail in International Patent Application No. PCT/US2020/058564, entitled “Electrochemical Cells with Separator Seals, and Methods of Manufacturing the Same,” filed Nov. 2, 2020 (the '564 application), the entire disclosure of which is hereby incorporated by reference in its entirety.

In some embodiments, the amount of semi-solid electrode material mixed together can be enough to form a large number of semi-solid electrodes. Mixing together a large amount of material can promote a more continuous production process, as semi-solid electrode materials do not have to be refilled as frequently. In some embodiments, the amount of semi-solid electrode material mixed together can be enough to form at least about 50 semi-solid electrodes, at least about 60 semi-solid electrodes, at least about 70 semi-solid electrodes, at least about 80 semi-solid electrodes, at least about 90 semi-solid electrodes, at least about 100 semi-solid electrodes, at least about 150 semi-solid electrodes, at least about 200 semi-solid electrodes, at least about 250 semi-solid electrodes, at least about 300 semi-solid electrodes, at least about 350 semi-solid electrodes, at least about 400 semi-solid electrodes, at least about 450 semi-solid electrodes, at least about 500 semi-solid electrodes, at least about 550 semi-solid electrodes, at least about 600 semi-solid electrodes, at least about 650 semi-solid electrodes, at least about 700 semi-solid electrodes, at least about 750 semi-solid electrodes, at least about 800 semi-solid electrodes, at least about 850 semi-solid electrodes, at least about 900 semi-solid electrodes, at least about 950 semi-solid electrodes, or at least about 1,000 semi-solid electrodes, inclusive of all values and ranges therebetween.

In the optional step 13, a vacuum can be applied to the semi-solid electrode material to de-gas the semi-solid electrode material. In some embodiments, the vacuum can be applied prior to addition of the electrolyte. In some embodiments, the vacuum can be applied after the addition of the electrolyte. In some embodiments, the vacuum can be applied concurrently with the mixing (i.e., at step 12). In some embodiments, the vacuum can occur in the same vessel as the mixing. In some embodiments, the vacuum can occur in a different vessel from the mixer. In some embodiments, the vacuum can reduce the pressure in a vessel containing the semi-solid electrode material by at least about 0.05 bar, at least about 0.1 bar, at least about 0.15 bar, at least about 0.2 bar, at least about 0.25 bar, at least about 0.3 bar, at least about 0.35 bar, at least about 0.4 bar, at least about 0.45 bar, at least about 0.5 bar, at least about 0.55 bar, at least about 0.6 bar, at least about 0.65 bar, at least about 0.7 bar, at least about 0.75 bar, at least about 0.80 bar, at least about 0.85 bar, at least about 0.90 bar, at least about 0.95 bar, or at least about 1 bar, inclusive of all values and ranges therebetween.

At step 14, the semi-solid electrode material is compressed to form a semi-solid electrode brick. In some embodiments, the compressing can be in the same vessel as the mixing (i.e., step 12). In some embodiments, the compressing can be in the same vessel as the vacuum (i.e., step 13). In some embodiments, the compressing can be in a different vessel from the mixing. In some embodiments, the compressing can be in a different vessel from the vacuum. In some embodiments, the compressing can increase the density of the semi-solid electrode material by a factor of at least about 1, at least about 1.1, at least about 1.2, at least about 1.3, at least about 1.4, at least about 1.5, at least about 1.6, at least about 1.7, at least about 1.8, at least about 1.9, or at least about 2, inclusive of all values and ranges therebetween. In some embodiments, the compressing can reduce the electrolyte content in the semi-solid electrode material by a factor of at least about 1, at least about 1.1, at least about 1.2, at least about 1.3, at least about 1.4, at least about 1.5, at least about 1.6, at least about 1.7, at least about 1.8, at least about 1.9, or at least about 2, inclusive of all values and ranges therebetween. In some embodiments, the compressing can include any of the methods described in the '192 publication.

In some embodiments, the semi-solid electrode brick formed in step 14 can include a sufficient amount of semi-solid electrode material to form at least about 50 semi-solid electrodes, at least about 60 semi-solid electrodes, at least about 70 semi-solid electrodes, at least about 80 semi-solid electrodes, at least about 90 semi-solid electrodes, at least about 100 semi-solid electrodes, at least about 150 semi-solid electrodes, at least about 200 semi-solid electrodes, at least about 250 semi-solid electrodes, at least about 300 semi-solid electrodes, at least about 350 semi-solid electrodes, at least about 400 semi-solid electrodes, at least about 450 semi-solid electrodes, at least about 500 semi-solid electrodes, at least about 550 semi-solid electrodes, at least about 600 semi-solid electrodes, at least about 650 semi-solid electrodes, at least about 700 semi-solid electrodes, at least about 750 semi-solid electrodes, at least about 800 semi-solid electrodes, at least about 850 semi-solid electrodes, at least about 900 semi-solid electrodes, at least about 950 semi-solid electrodes, or at least about 1,000 semi-solid electrodes, inclusive of all values and ranges therebetween.

In some embodiments, the electrode brick can stand on its own without crumbling. In other words, the electrode brick can have sufficient cohesive properties and/or structural stability such that it stands on a surface without supports and without crumbling. In some embodiments, the electrode brick can stand with its longest dimension vertical without supports and without crumbling. In some embodiments, the electrode brick can have a length of at least about 10 cm, at least about 15 cm, at least about 20 cm, at least about 25 cm, at least about 30 cm, at least about 35 cm, at least about 40 cm, at least about 45 cm, at least about 50 cm, at least about 55 cm, at least about 60 cm, at least about 65 cm, at least about 70 cm, at least about 75 cm, or at least about 80 cm. In some embodiments, the electrode brick can have a width of at least about 5 cm, at least about 10 cm, at least about 15 cm, at least about 20 cm, at least about 25 cm, at least about 30 cm, at least about 35 cm, at least about 40 cm, at least about 45 cm, at least about 50 cm, at least about 55 cm, or at least about 60 cm. In some embodiments, the electrode brick can have a thickness of at least about 0.5 cm, at least about 1 cm, at least about 1.5 cm, at least about 2 cm, at least about 2.5 cm, at least about 3 cm, at least about 3.5 cm, at least about 4 cm, at least about 4.5 cm, or at least about 5 cm.

In some embodiments, the electrode brick can have a density of at least about 1 g/cm³, at least about 1.5 g/cm³, at least about 2 g/cm³, at least about 2.5 g/cm³, at least about 3 g/cm³, at least about 3.5 g/cm³, at least about 4 g/cm³, or at least about 4.5 g/cm³. In some embodiments, the electrode brick can have a density of no more than about 5 g/cm³, no more than about 4.5 g/cm³, no more than about 4 g/cm³, no more than about 3.5 g/cm³, no more than about 3 g/cm³, no more than about 2.5 g/cm³, no more than about 2 g/cm³, or no more than about 1.5 g/cm³. Combinations of the above-referenced densities of the electrode brick are also possible (e.g., at least about 1 g/cm³ and no more than about 5 g/cm³ or at least about 2 g/cm³ and no more than about 4 g/cm³), inclusive of all values and ranges therebetween. In some embodiments, the electrode brick can have a density of at least about 1 g/cm³, at least about 1.5 g/cm³, at least about 2 g/cm³, at least about 2.5 g/cm³, at least about 3 g/cm³, at least about 3.5 g/cm³, at least about 4 g/cm³, at least about 4.5 g/cm³, or about 5 g/cm³.

The method 10 optionally includes step 15, laser cutting metal foil to form a current collector. In some embodiments, step 15 occurs as part of a different process from step 12, 13, and 14. In some embodiments, step 15 occurs on a different conveyor or conveyance system from the other steps of the method 10. Laser cutting is a beneficial method of current collector formation, as blades and rotary tools can often wear out over time. In step 15, a foil is applied to a pouch material or a film material. The laser cutting process is then applied to the foil to form the current collector. In some embodiments, the laser cutting process can include a kiss-cutting process. In some embodiments, the precision of the laser cutting process can minimize any cutting of the pouch material. In other words, the margin of error of the laser cutting process can be small enough such that the foil is completely cut without any significant cutting of the pouch material. In some embodiments, the laser cutting can be to a precision (i.e., margin of error) of less than about 500 nm, less than about 450 nm, less than about 400 nm, less than about 350 nm, less than about 300 nm, less than about 250 nm, less than about 200 nm, less than about 150 nm, less than about 100 nm, less than about 90 nm, less than about 80 nm, less than about 70 nm, less than about 60 nm, less than about 50 nm, less than about 40 nm, less than about 30 nm, less than about 20 nm, or less than about 10 nm.

In some embodiments, the foil (and subsequently the current collector) can have a thickness of at least about 500 nm, at least about 1 μm, at least about 1.5 μm, at least about 2 μm, at least about 2.5 μm, at least about 3 μm, at least about 3.5 μm, at least about 4 μm, at least about 4.5 μm, at least about 5 μm, at least about 5.5 μm, at least about 6 μm, at least about 6.5 μm, at least about 7 μm, at least about 7.5 μm, at least about 8 μm, at least about 8.5 μm, at least about 9 μm, or at least about 9.5 μm. In some embodiments, the foil can have a thickness of no more than about 10 μm, no more than about 9.5 μm, no more than about 9 μm, no more than about 8.5 μm, no more than about 8 μm, no more than about 7.5 μm, no more than about 7 μm, no more than about 6.5 μm, no more than about 6 μm, no more than about 5.5 μm, no more than about 5 μm, no more than about 4.5 μm, no more than about 4 μm, no more than about 3.5 μm, no more than about 3 μm, no more than about 2.5 μm, no more than about 2 μm, no more than about 1.5 μm, or no more than about 1 μm. Combinations of the above-reference ranges for foil thicknesses are also possible (e.g., at least about 500 nm and no more than about 10 μm or at least about 1 μm and no more than about 5 μm), inclusive of all values and ranges therebetween. In some embodiments, the foil can have a thickness of about 500 nm, about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, or about 10 μm.

At step 16, a portion of the semi-solid electrode brick is dispensed onto the current collector to form a semi-solid electrode. In some embodiments, the dispensing of the portion of the semi-solid electrode brick can be from the same vessel where the compressing occurred (i.e., step 14). In some embodiments, the dispensing can be from a different vessel from where the compressing occurred. In some embodiments, the dispensing can be from a cartridge with a nozzle. In some embodiments, the dispensing can be onto a conveyor or a conveyance system.

At step 17, the semi-solid electrode is conveyed (e.g., via a conveyor belt) through formers. In some embodiments, the formers can be affixed to the same device that performs the dispensing at step 16. In some embodiments, the formers can include a top blade that controls the thickness of the semi-solid electrode. In some embodiments, the formers can include one or more side plates to control the width of the semi-solid electrode. Rigid control of the edges of the semi-solid electrode can improve edge integrity and reduce crumbling. In some embodiments, the side plates can form a seal with the conveyor, the pouch material, or the current collector so that no semi-solid electrode material leaks out or is pushed out through a bottom region of the semi-solid electrode. In some embodiments, the transverse edges of the semi-solid electrode can be controlled by pinching the pouch material between adjacent plates on the conveyor. In some embodiments, step 17 can include high speed micron-level adjustments of the top blade in the z-direction (i.e., toward and away from the conveyor). In some embodiments, x-ray gauges and/or beta gauges can be used to monitor electrode thickness for consistency. In some embodiments, a closed loop algorithm can be employed with the x-ray gauges and/or the beta gauges to narrow the margin of error in semi-solid electrode thickness from one semi-solid electrode to the next. In other words, the margin of error of the electrode thickness can be narrowed in situ. In some embodiments, the algorithm can be applied to smooth movements of the top blade in the z-direction (i.e., making adjustments gradual to avoid unsmooth surfaces on semi-solid electrodes).

The method 10 optionally includes wetting the semi-solid electrode with a solvent at step 18. Solvent (i.e., electrolyte solvent) can evaporate during any part of the method 10. This can reduce the movement of electroactive species through the semi-solid electrode and subsequent electrochemical cell. Thus, replacement of this solvent can aid in reducing the probability of such occurrences. In some embodiments, the wetting at step 18 can include spraying. In some embodiments, step 18 can include spraying a solvent. In some embodiments, step 18 can include spraying an electrolyte. In some embodiments, step 18 can include spraying a solvent and spraying an electrolyte. In some embodiments, step 18 can include spraying a solvent onto the semi-solid electrode. In some embodiments step 18 can include spraying an electrolyte onto the semi-solid electrode. In some embodiments, step 18 can include spraying both a solvent and an electrolyte onto the semi-solid electrode. In some embodiments, step 18 can include ink jet printing the solvent for high precision application. Ink jet printing can limit or completely eliminate overspray. In some embodiments, a separator can be disposed onto the semi-solid electrode prior to step 18 and the spraying can be onto the separator. In some embodiments, step 18 can include spraying a solvent onto the separator. In some embodiments step 18 can include spraying an electrolyte onto the separator. In some embodiments, step 18 can include spraying both a solvent and an electrolyte onto the separator. In some embodiments, step 18 can include ink jet printing the solvent for high precision application.

In some embodiments, step 18 can include spraying hard carbon. In some embodiments, step 18 can include spraying a hard carbon suspension. In some embodiments, step 18 can include applying a hard carbon suspension onto the semi-solid electrode. In some embodiments, step 18 can include spraying a hard carbon suspension onto the semi-solid electrode. In some embodiments, step 18 can include applying a hard carbon suspension onto the separator. In some embodiments, step 18 can include spraying a hard carbon suspension onto the separator. Examples of electrodes, separators, and electrochemical cells that incorporate hard carbon are described in International Patent Application No. PCT/US2021/038921, entitled “Electrochemical Cells with Multi-Layered Electrodes and Coated Separators and Methods of Making the Same,” filed Jun. 24, 2021 (the '921 application), the entire disclosure of which is hereby incorporated by reference in its entirety. In some embodiments, spraying the separator with solvent can make the solvent adhere to the semi-solid electrode more easily. In some embodiments, the spraying can be onto the semi-solid electrode. In some embodiments, the solvent can include an electrolyte salt. In some embodiments, the solvent can be without the electrolyte salt. In some embodiments, the solvent can be added (e.g., via spraying) to a conventional electrode (i.e., a solid electrode) with an electrolyte salt. Wetting a large format conventional electrode can be difficult. Wetting the large area of the conventional electrode with an electrolyte and/or solvent before assembly can be beneficial in conventional electrochemical cell manufacture (e.g., conventional Li ion electrochemical cell manufacturing).

At step 19, the semi-solid electrode can optionally be conveyed through a tunnel. The tunnel can aid in preventing evaporation of the solvent. In other words, the tunnel can reduce the venting effect of the semi-solid electrode being exposed to the surrounding environment. Any portion of the conveyor or the conveyance system can include a tunnel overhead. In other words, the tunnel can be deployed during any part of the method 10 (e.g., before step 18).

At step 21, the semi-solid electrode can optionally be adjoined to an additional electrode (i.e., an adjoining electrode) interposed by a separator to form an electrochemical cell. In some embodiments, the adjoining electrode can come from a different conveyor or conveyance system from the semi-solid electrode. In some embodiments, the adjoining electrode can be placed on top of the semi-solid electrode from above. In some embodiments, the adjoining electrode can be a conventional electrode. In some embodiments, the adjoining electrode can be an additional semi-solid electrode. Further examples of adjoining methods and adjoining systems are described in the '025 publication.

At step 23, the electrochemical cell can optionally be sealed in a pouch. In some embodiments, the sealing of the pouch can be via impulse heating. Sealing methods of pouches often use a sealing device with constant heat applied to the sealing device. In the presence of such heat, pouch materials can warp and wrinkle. Additionally, electrolyte from the semi-solid electrode can evaporate in such heat. With the use of impulse heating, the application of heat is very quick, such that the surrounding environment does not significantly increase in temperature. In addition, the sealing at step 23 can be via a single sealing apparatus. In other words, a single apparatus can seal all around the perimeter of the pouch in one motion, rather than sealing just one side at a time via multiple passes or multiple sealing devices.

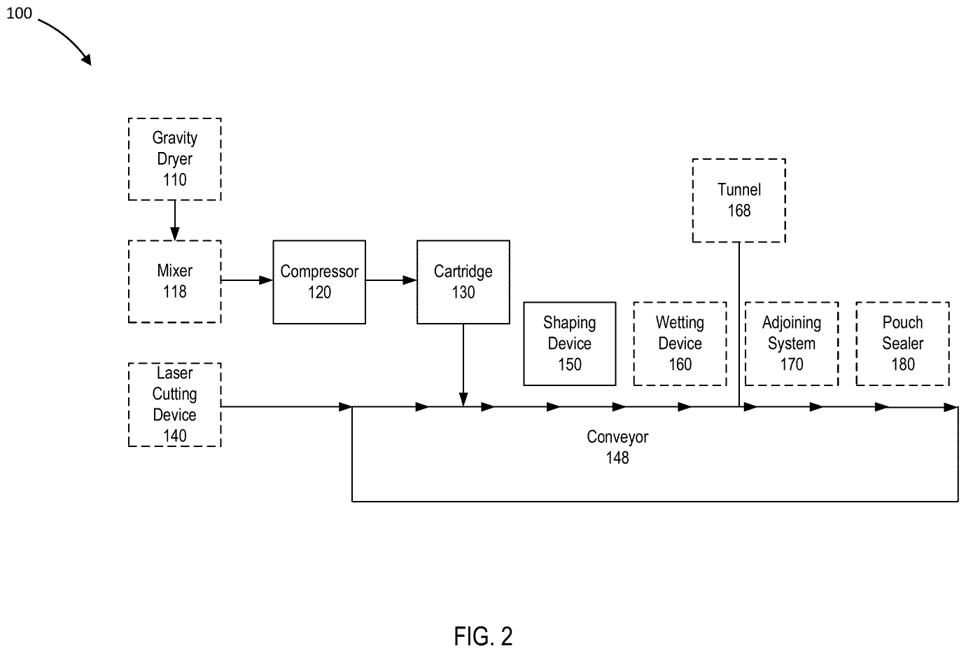

FIG. 2 is a schematic diagram of a system 100 for semi-continuous or continuous manufacture of a semi-solid electrode, according to an embodiment. As shown, the system 100 includes a compressor 120, a cartridge 130, a conveyor 148, and a shaping device 150. In some embodiments, the system 100 can include a gravity dryer 110, a mixer 118, a laser cutting device 140, a wetting device 160, a tunnel 168, an adjoining system 170, and a pouch sealer 180. In some embodiments, the system 100 can be used for implementing the method 10, as described above with reference to FIG. 1.

In some embodiments, the gravity dryer 110 can include a vessel, through which a powder can be conveyed via gravity. In some embodiments, the gravity dryer can include a gas inlet and a gas outlet for drying gas. In some embodiments, the gravity dryer 110 can be maintained at a moisture content of less than about 1 ppm, less than about 0.9 ppm, less than about 0.8 ppm, less than about 0.7 ppm, less than about 0.6 ppm, less than about 0.5 ppm, less than about 0.4 ppm, less than about 0.3 ppm, less than about 0.2 ppm, less than about 0.1 ppm, less than about 0.09 ppm, less than about 0.08 ppm, less than about 0.07 ppm, less than about 0.06 ppm, less than about 0.05 ppm, less than about 0.04 ppm, less than about 0.03 ppm, less than about 0.02 ppm, or less than about 0.01 ppm, inclusive of all values and ranges therebetween.

The mixer 118 mixes active material, conductive material, and electrolyte to form a semi-solid electrode material. In some embodiments, the mixer 118 can include a twin-screw extruder. In some embodiments, the mixer 118 can include a twin-screw kneader. In some embodiments, the mixer can include any of the mixers mentioned in the '569 patent. In some embodiments, the mixer 118 can be fluidically coupled to the gravity dryer 110 such that material can flow continuously from the gravity dryer 110 to the mixer 118.

The compressor 120 forms the semi-solid electrode material into a semi-solid electrode brick. In some embodiments, the compressor 120 can be fluidically coupled to the mixer 118, such that the semi-solid electrode material can flow continuously from the mixer 118 to the compressor 120. In some embodiments, the compressor 120 can be fluidically coupled to a vacuum. In some embodiments, the compressor 120 can include a piston for compressing. In some embodiments, the compressor 120 can be part of the same apparatus as the mixer 118. In other words, the same apparatus can both mix and compress the electrode material.

The cartridge 130 contains semi-solid electrode bricks and dispenses portions of the semi-solid electrode bricks onto current collectors to form semi-solid electrodes. In some embodiments, the cartridge 130 can include a nozzle for dispensation. In some embodiments, the cartridge 130 can be part of the same structure or apparatus as the compressor 120 and/or the mixer 118.

The laser cutting device 140 cuts foil to form current collectors. In some embodiments, the laser cutting device 140 can perform kiss cutting. In some embodiments, the laser cutting device 140 can be to a precision (i.e., margin of error) of less than about 500 nm, less than about 450 nm, less than about 400 nm, less than about 350 nm, less than about 300 nm, less than about 250 nm, less than about 200 nm, less than about 150 nm, less than about 100 nm, less than about 90 nm, less than about 80 nm, less than about 70 nm, less than about 60 nm, less than about 50 nm, less than about 40 nm, less than about 30 nm, less than about 20 nm, or less than about 10 nm.

The conveyor 148 moves semi-solid electrodes through the additional process units of the system 100. In some embodiments, the system can include multiple conveyors (not shown). In some embodiments, multiple conveyors can be used to put multiple electrodes together, as described in the '025 publication.

The shaping device 150 shapes the edges of the semi-solid electrode. In other words, the shaping device 150 controls the edges of the semi-solid electrode. In some embodiments, the shaping device 150 can include a single frame for shaping the outside edges of the semi-solid electrode. In some embodiments, the shaping device 150 can include a top blade for controlling the thickness of the semi-solid electrode and side plates for controlling the width of the semi-solid electrodes. In some embodiments, the shaping device 150 can adjust with micron level precision. In some embodiments, the shaping device 150 can learn in closed loop process algorithms. In some embodiments, the shaping device 150 can be part of the same structure as the cartridge 130. In other words, the top blade and the side plates can be attached to the cartridge 130.

The wetting device 160 wets the semi-solid electrode with electrolyte solvent to replace electrolyte solvent lost during production. In some embodiments, the wetting device can include a sprayer. In some embodiments, the tunnel 168 can be disposed throughout the conveyor 148. In some embodiments, the tunnel 168 can be disposed adjacent to the wetting device 160 to reduce evaporation of the electrolyte from the semi-solid electrode.

In some embodiments, the adjoining system 170 can bring an additional electrode together with the semi-solid electrode to form an electrochemical cell. In some embodiments, the adjoining system 170 can include a second conveyor. Further examples of adjoining systems are described in the '025 publication.

In some embodiments, the pouch sealer 180 seals the pouch around the outside edges of the electrochemical cell. In some embodiments, the pouch sealer 180 can include an impulse heater. In some embodiments, the pouch sealer 180 can have a shape, such that it can seal around the outside edge of the electrochemical cell in a single step.

In some embodiments, the system 100 can be enclosed in a main enclosure, which controls the environment, in which each of the electrodes are produced, and the electrochemical cells are assembled. In some embodiments, the system 100 can include multiple conveyors 148. In some embodiments, the system 100 can include an anode casting station and a cathode casting station. In some embodiments, the anode casting station can include a first conveyor and the cathode casting station can include a second conveyor. In some embodiments, the anode casting station and/or the cathode casting station can include a cartridge that dispenses materials onto transverse steering platforms. In some embodiments, the cartridge at the anode casting station dispenses an anode material, while the cartridge at the cathode casting station dispenses a cathode material. In some embodiments, the cartridges can dispense portions of semi-solid electrode bricks. In some embodiments, each of the anode and cathode casting stations can include optical measurement devices as well as x-rays. The optical measurement devices and x-rays can be used for quality control to confirm the thickness of the semi-solid electrodes after being formed. In some embodiments, the anode can be formed at the anode casting station with the anode material disposed on a current collector and/or a pouch material. In some embodiments, the cathode can be formed at the cathode casting station with the cathode material disposed on a current collector and/or a pouch material.

After being formed at the cathode forming station, the cathode material can be passed through a spray enclosure. In some embodiments, the wetting device 160 and/or the tunnel 168 can be inside the spray enclosure. In some embodiments, solvents can be sprayed on the anode material and/or the cathode material in the spray enclosure. In some embodiments, the solvents sprayed on the cathode material can be flammable. The use of a spray enclosure can aid in preventing ignition by keeping concentration levels of flammable materials outside of an ignitable range. In some embodiments, the spray enclosure includes an exhaust to vent the spray enclosure to the surrounding environment and keep the concentration of flammable materials below a flammable limit. In some embodiments, the spray enclosure can be explosion proof. In some embodiments, the cathode material can pass through a spray enclosure. In some embodiments, the anode material can pass through a spray enclosure. In some embodiments, the anode material can pass through a first spray enclosure and the cathode material can pass through a second spray enclosure. In some embodiments, the anode material and the cathode material can pass through the same spray enclosure.

In some embodiments, the spray enclosure can be purged of oxygen to reduce the risk of ignition inside the enclosure. In some embodiments, the purging of oxygen can be via vacuuming the spray enclosure. In some embodiments, the purging of oxygen can be via influx of inert gas (e.g., nitrogen, argon) into the spray enclosure. In some embodiments, the purging of oxygen can be via vacuuming the spray enclosure and influx of inert gas into the spray enclosure.

In some embodiments, the formed anode material, the formed cathode material, and a separator material can all be fed to a vacuum drum (not shown), where the anode material, the cathode material, and the separator are merged together. In some embodiments, each of the anode material, the cathode material, and the separator can wrap around the vacuum drum at different points along the vacuum drum to form the layers of the electrochemical cell. In some embodiments, the vacuum drum can apply a force to the electrodes to increase their densities. In some embodiments, the vacuum drum can apply a downward force on the electrodes, such that the electrodes experience a pressure of at least about 1 MPa, at least about 2 MPa, at least about 3 MPa, at least about 4 MPa, at least about 5 MPa, at least about 6 MPa, at least about 7 MPa, at least about 8 MPa, or at least about 9 MPa. In some embodiments, the vacuum drum can apply a downward force on the electrodes, such that the electrodes experience a pressure of no more than about 10 MPa, no more than about 9 MPA, no more than about 8 MPA, no more than about 7 MPA, no more than about 6 MPA, no more than about 5 MPA, no more than about 4 MPA, no more than about 3 MPA, or no more than about 2 MPA. Combinations of the above-referenced pressures experienced by the electrodes due to the downward force of the vacuum drum are also possible (e.g., at least about 1 MPa and no more than about 10 MPa or at least about 3 MPa and no more than about 7 MPa), inclusive of all values and ranges therebetween. In some embodiments, the vacuum drum can apply a downward force on the electrodes, such that the electrodes experience a pressure of about 1 MPa, about 2 MPa, about 3 MPa, about 4 MPa, about 5 MPa, about 6 MPa, about 7 MPa, about 8 MPa, about 9 MPa, or about 10 MPa.

In some embodiments, the vacuum drum can have a diameter of at least about 1 cm, at least about 5 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the vacuum drum can have a diameter of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, or no more than about 5 cm. Combinations of the above-referenced diameters of the vacuum drum are also possible (e.g., at least about 1 cm and no more than about 1 m or at least about 10 cm and no more than about 50 cm), inclusive of all values and ranges therebetween. In some embodiments, the vacuum drum can have a diameter of about 1 cm, about 5 cm, about 10 cm, about 20 cm, about 30 cm, about 40 cm, about 50 cm, about 60 cm, about 70 cm, about 80 cm, about 90 cm, or about 1 m.

In some embodiments, the vacuum drum can be held in place with a tack. In some embodiments, the vacuum drum can include multiple members disposed around a perimeter of the vacuum drum. In some embodiments, the members can include pallets. In some embodiments, the vacuum drum can include a central duct with a vacuum for removal of liquids from the material on the outside of the vacuum drum. After merging together, a laser cutter can cut the anode material, the cathode material, and the separator to form individual electrochemical cells. As shown, the individual electrochemical cells can be conveyed across a vacuum conveyor. In some embodiments, the vacuum conveyor can remove stray particles from the electrochemical cells. The individual electrochemical cells can be measured via optical measurement for quality control. The individual electrochemical cells can then selectively slide off of the vacuum conveyor, depending on whether they pass the quality control test.

In some embodiments, the system 100 can include a first vacuum drum that receives a feed of cathode material and separator material and a second vacuum drum that receives a feed of anode material. In some embodiments, the first vacuum drum presses the separator material and the cathode material to a conveyor, and then the second vacuum drum presses the anode material onto the cathode material and the separator.

In some embodiments, the anode casting station and/or the cathode casting station can include a densification station (not shown). In some embodiments, the densification station can employ any of the electrode densification methods described in the '192 publication.

In some embodiments, the system 100 can produce at least about 100, at least about 150, at least about 200, at least about 250, at least about 300, at least about 350, at least about 400, at least about 450, at least about 500, at least about 550, at least about 600, at least about 650, at least about 700, at least about 750, at least about 800, at least about 850, at least about 900, at least about 950, or at least about 1,000 electrodes per minute, inclusive of all values and ranges therebetween. In some embodiments, the system 100 can produce at least about 100, at least about 150, at least about 200, at least about 250, at least about 300, at least about 350, at least about 400, at least about 450, at least about 500, at least about 550, at least about 600, at least about 650, at least about 700, at least about 750, at least about 800, at least about 850, at least about 900, at least about 950, or at least about 1,000 electrochemical cells per minute, inclusive of all values and ranges therebetween.

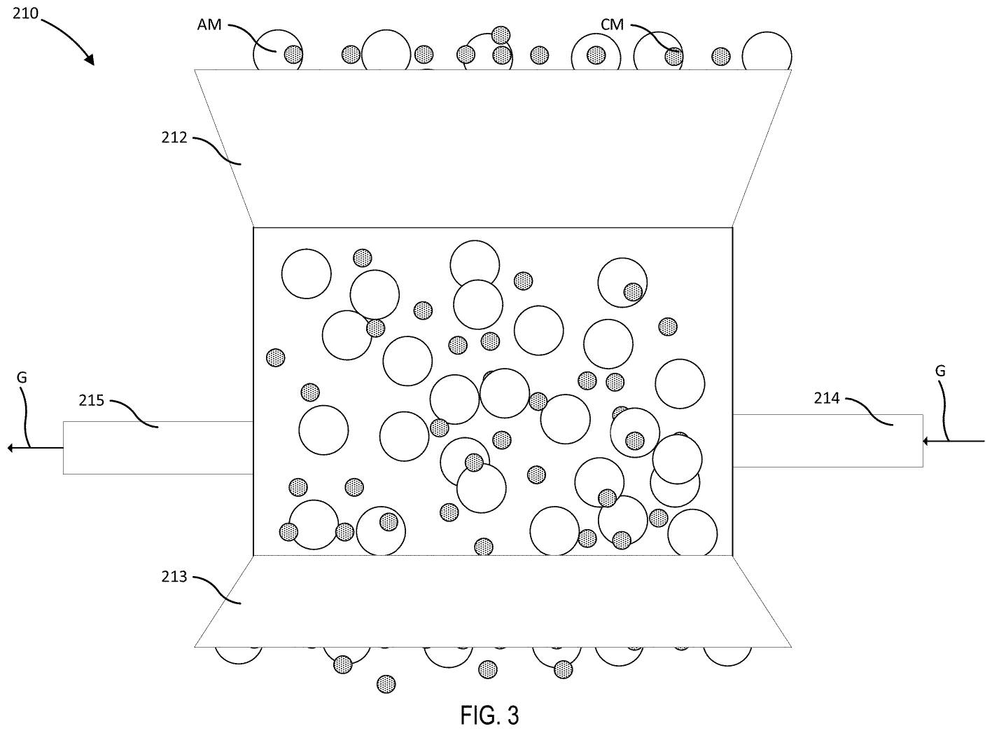

FIG. 3 illustrates a gravity dryer 210, according to an embodiment. In some embodiments, the gravity dryer 210 can be the same or substantially similar to the gravity dryer 110, as described above with reference to FIG. 2. Thus, certain aspects of the gravity dryer 210 are not described in greater detail herein. As shown, the gravity dryer 210 includes a powder loading port 212, a powder exhaust port 213, a gas inlet 214, and a gas outlet 215. As shown, the powder includes active material AM and conductive material CM, fed into the gravity dryer 210. The powder falls through the gravity dryer 210 while gas G is fed through the gravity dryer 210.

In some embodiments, the powder loading port 212 can include a mesh to filter out larger particles. In some embodiments, the powder loading port 212 can include a funneled opening for ease of pouring. The exit port 213 expels the powder from the gravity dryer. In some embodiments, the exit port 213 can be fluidically coupled to another process unit (e.g., a mixer). The gas G is fed into the gravity dryer 210 via the gas inlet. In some embodiments, the gas G can be fed at positive pressure. In some embodiments, the gas G can be fed at a pressure of at least about 1 bar, at least about 1.5 bar, at least about 2 bar, at least about 2.5 bar, at least about 3 bar, at least about 3.5 bar, at least about 4 bar, at least about 4.5 bar, at least about 5 bar, at least about 5.5 bar, at least about 6 bar, at least about 6.5 bar, at least about 7 bar, at least about 7.5 bar, at least about 8 bar, at least about 8.5 bar, at least about 9 bar, or at least about 9.5 bar. In some embodiments, the gas G can be fed at a pressure of no more than about 10 bar, no more than about 9.5 bar, no more than about 9 bar, no more than about 8.5 bar, no more than about 8 bar, no more than about 7.5 bar, no more than about 7 bar, no more than about 6.5 bar, no more than about 6 bar, no more than about 5.5 bar, no more than about 5 bar, no more than about 4.5 bar, no more than about 4 bar, no more than about 3.5 bar, no more than about 3 bar, no more than about 2.5 bar, no more than about 2 bar, or no more than about 1.5 bar. Combinations of the above referenced pressures of the gas G fed to the gravity dryer 210 are also possible (e.g., at least about 1 bar and no more than about 10 bar or at least about 2 bar and no more than about 5 bar), inclusive of all values and ranges therebetween. In some embodiments, the gas G can be fed at a pressure of about 1 bar, about 1.5 bar, about 2 bar, about 2.5 bar, about 3 bar, about 3.5 bar, about 4 bar, about 4.5 bar, about 5 bar, about 5.5 bar, about 6 bar, about 6.5 bar, about 7 bar, about 7.5 bar, about 8 bar, about 8.5 bar, about 9 bar, about 9.5 bar, or about 10 bar.

As shown, the gravity dryer 210 includes a single gas inlet 214 and a single gas outlet 215. In some embodiments, the gravity dryer 210 can include multiple gas inlets 214 and/or gas outlets 215. In some embodiments, the gravity dryer 210 can include at least about 2, at least about 3, at least about 4, at least about 5, at least about 6, at least about 7, at least about 8, at least about 9, or at least about 10 gas inlets 214 and/or gas outlets 215. As shown, the gas G flows perpendicular to the flow of the powder. In some embodiments, the gas G can flow counter current to the flow of the powder. In some embodiments, the gas G can flow parallel to the flow of the powder.

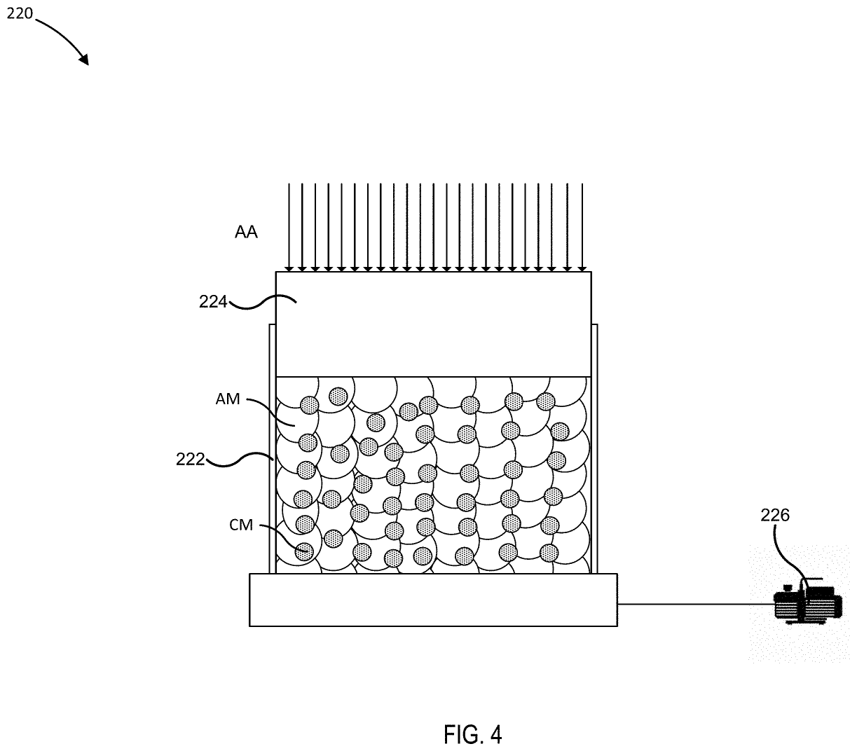

FIG. 4 is an illustration of a compressor 220, according to an embodiment. In some embodiments, the compressor 220 can be the same or substantially similar to the compressor 120, as described above with reference to FIG. 2. Thus, certain aspects of the compressor 220 are not described in greater detail herein. The compressor 220 forms the semi-solid electrode material into a semi-solid electrode brick. As shown, the compressor 220 includes a container 222, a piston 224, and a pump 226. Conductive material CM and active material AM are shown being compressed. In some embodiments, electrolyte can be included in the material being compressed (i.e., the material in the compressor 220 can be a semi-solid electrode). In some embodiments, electrolyte can be added to the compressor 220. In some embodiments, the electrolyte can be infused into the compressor 220. Methods and apparatus for infusion are described in greater detail in the '087 patent.

The container 222 holds the semi-solid electrode material in place during compression. In some embodiments, the container 222 can have a cylindrical shape, a cube shape, a rectangular prism shape, or any other suitable shape. In some embodiments, the container 222 can have a volume of at least about 0.1 L, at least about 0.5 L, at least about 1 L, at least about 5 L, at least about 10 L, at least about 50 L, at least about 100 L, at least about 500 L, at least about 1 m³, or at least about 5 m³. In some embodiments, the container 222 can have a volume of no more than about 10 m³, no more than about 5 m³, no more than about 1 m³, no more than about 500 L, no more than about 100 L, no more than about 50 L, no more than about 10 L, no more than about 5 L, no more than about 1 L, or no more than about 0.5 L. Combinations of the above-referenced volumes of the container 222 are also possible (e.g., at least about 0.1 L and no more than about 10 m³ or at least about 5 L and no more than about 10 L), inclusive of all values and ranges therebetween. In some embodiments, the container 222 can have a volume of about 0.1 L, about 0.5 L, about 1 L, about 5 L, about 10 L, about 50 L, about 100 L, about 500 L, about 1 m³, about 5 m³, or about 10 m³.

The piston 224 presses the semi-solid electrode material (i.e., by moving along lines AA) to form the semi-solid electrode brick. In some embodiments, the piston 224 can include a gasket around the edge to form a seal with the container 222. In some embodiments, the vacuum pump 226 can remove gas and/or electrolyte from the semi-solid electrode material in the container 222. In some embodiments, the vacuum pump can pull a vacuum of at least about 0.1 bar, at least about 0.2 bar, at least about 0.3 bar, at least about 0.4 bar, at least about 0.5 bar, at least about 0.6 bar, at least about 0.7 bar, at least about 0.8 bar, or at least about 0.9 bar, inclusive of all values and ranges therebetween.

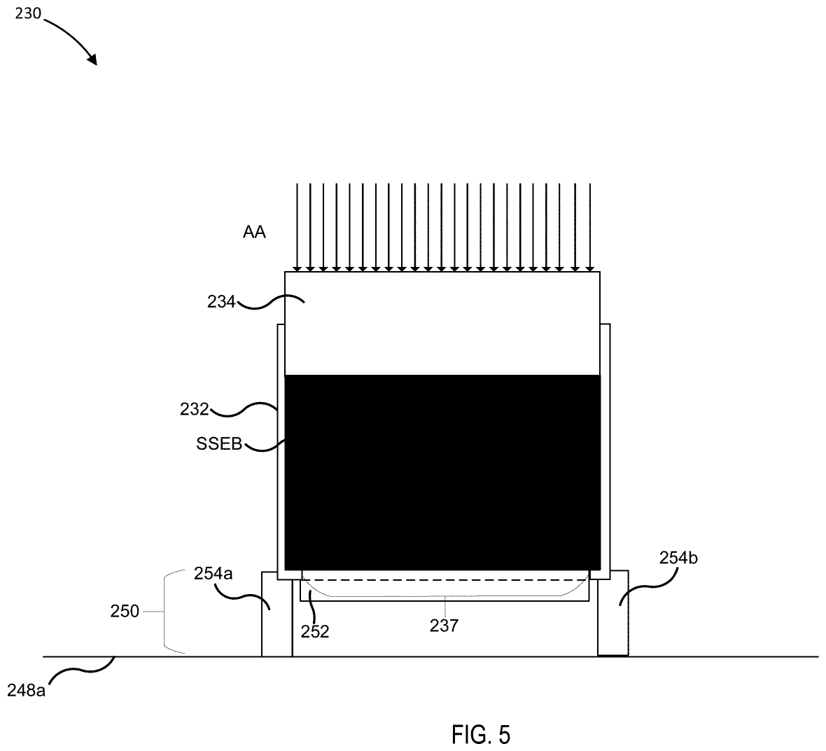

FIG. 5 is an illustration of a cartridge 230 with a shaping device 250, according to an embodiment. In some embodiments, the cartridge 230 and the shaping device 250 can be the same or substantially similar to the cartridge 130 and the shaping device 150, as described above with reference to FIG. 2. Thus, certain aspects of the cartridge 230 and the shaping device 250 are not described in greater detail herein. In some embodiments, the cartridge 230 can be part of the same structure as the compressor 220, as described above with reference to FIG. 4. In other words, a single apparatus can perform all of the functions of the compressor 230 and the cartridge 230. As shown, the cartridge 230 includes a container 232, a piston 234, and a nozzle opening 237, while the shaping device 250 (attached to the cartridge 230) includes a top blade 252 and side plates 254a, 254b (collectively referred to as side plates 254). As shown, the nozzle opening 237 is a broad opening obstructed by the top blade 252 and is thus depicted by a dotted line. The cartridge 230 can dispense portions of the semi-solid electrode brick SSEB onto a conveyor 248a.

The container 232 houses the semi-solid electrode brick SSEB. In some embodiments, the container 232 can have a cylindrical shape, a cube shape, a rectangular prism shape, or any other suitable shape. In some embodiments, the container 232 can have a volume of at least about 0.1 L, at least about 0.5 L, at least about 1 L, at least about 5 L, at least about 10 L, at least about 50 L, at least about 100 L, at least about 500 L, at least about 1 m³, or at least about 5 m³. In some embodiments, the container 232 can have a volume of no more than about 10 m³, no more than about 5 m³, no more than about 1 m³, no more than about 500 L, no more than about 100 L, no more than about 50 L, no more than about 10 L, no more than about 5 L, no more than about 1 L, or no more than about 0.5 L. Combinations of the above-referenced volumes of the container 232 are also possible (e.g., at least about 0.1 L and no more than about 10 m³ or at least about 5 L and no more than about 10 L), inclusive of all values and ranges therebetween. In some embodiments, the container 232 can have a volume of about 0.1 L, about 0.5 L, about 1 L, about 5 L, about 10 L, about 50 L, about 100 L, about 500 L, about 1 m³, about 5 m³, or about 10 m³. The piston 234 pushes the semi-solid electrode brick SSEB, such that a portion of the semi-solid electrode brick SSEB exits the cartridge 230 via the nozzle opening 237.

As shown, the top blade 252 controls the thickness of the semi-solid electrode while the side plates 254 control the width of the semi-solid electrode. In some embodiments, the top blade 252 and/or the side plates 254 can adjust with micron level precision. In some embodiments, the top blade 252 and/or the side plates 254 can be controlled by an algorithm that can learn in closed loop process algorithms. In some embodiments, the side plates 254 can create seals with the conveyor 248a, to prevent portions of the semi-solid electrode from flowing sideways out the nozzle. In some embodiments, the side plates 254 can be clamped to the cartridge 230 via a clamp plate. In some embodiments, the side plates can be composed of polyethylene terephthalate (PET). In some embodiments, the side plates can have a thickness of about 0.15 mm, about 0.2 mm, or about 0.25 mm, inclusive of all values and ranges therebetween.

In some embodiments, supports can be placed below the conveyor 248a to prevent deflection of the conveyor 248a due to the force exerted from the casting of the semi-solid electrode brick SSEB onto the conveyor 248a. In some embodiments, the conveyor 248a can be supported from above (e.g., via beams hanging from a ceiling) to prevent deflection of the conveyor 248a due to the force exerted from the casting of the semi-solid electrode brick SSEB onto the conveyor 248a.

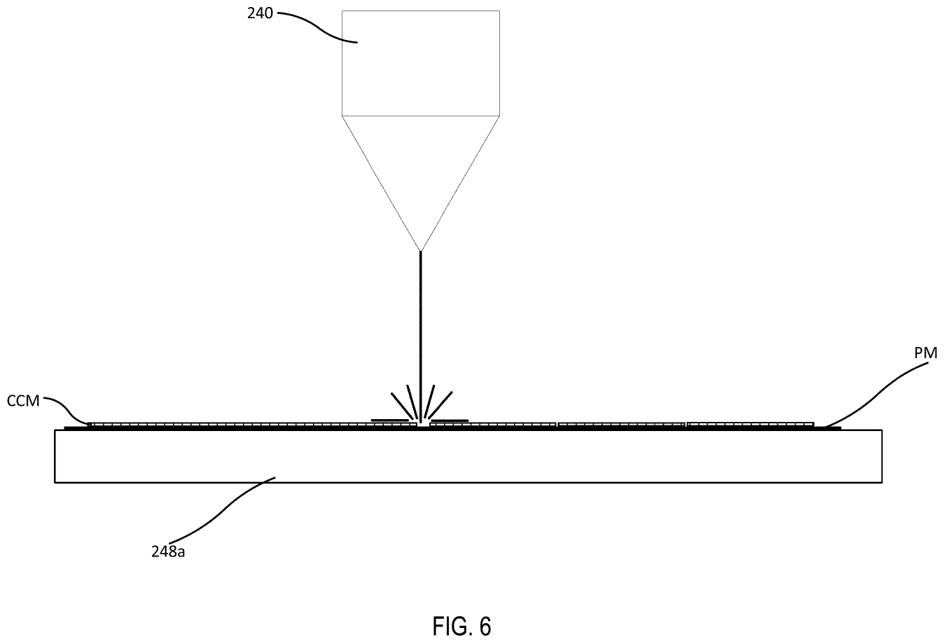

FIG. 6 illustrates a laser cutter 240, according to an embodiment. The laser cutter 240 cuts current collector material CCM being conveyed along a conveyor 248b. In some embodiments, the laser cutter 240 can be the same or substantially similar to the laser cutter 140, as described above with reference to FIG. 2. Thus, certain aspects of the laser cutter 240 are not described in greater detail herein. The current collector material CCM is applied to a pouch material PM and cut via the laser cutter 240. In some embodiments, portions of the current collector material CCM are removed to create a region of pouch material PM around the edge of the current collector material CCM for sealing. In some embodiments, the laser cutter 240 can have a precision (i.e., margin of error) of less than about 500 nm, less than about 450 nm, less than about 400 nm, less than about 350 nm, less than about 300 nm, less than about 250 nm, less than about 200 nm, less than about 150 nm, less than about 100 nm, less than about 90 nm, less than about 80 nm, less than about 70 nm, less than about 60 nm, less than about 50 nm, less than about 40 nm, less than about 30 nm, less than about 20 nm, or less than about 10 nm.

In some embodiments, the conveyor 248a can advance horizontally. In some embodiments, the conveyor 248a can include multiple members or pallets (not shown) arranged side-by-side, advancing in a horizontal direction. In some embodiments, rotating wheels or drums on either side of the conveyor 248a can facilitate movement of the conveyor 248a. In some embodiments, one or more tucking fingers can be housed inside the conveyor 248a to tuck portions of the current collector material CCM into gaps between the pallets. In some embodiments tucking fingers housed inside the conveyor 248a can include a vacuum therein, such that the tucking finger can contact the current collector material CCM (or a conveyor belt on which the current collector material CCM sits) and pull the current collector material CCM into the gaps between the pallets. In some embodiments, the pallets can come together to pinch the tucked portions of current collector material CCM. Tucking/pinching portions of the current collector material CCM prior to casting electrode material onto the conveyor 248a can aid in creating space between the electrode material, when the pallets are later released and spaced apart from each other once again. The electrode material can separate into discrete electrodes.

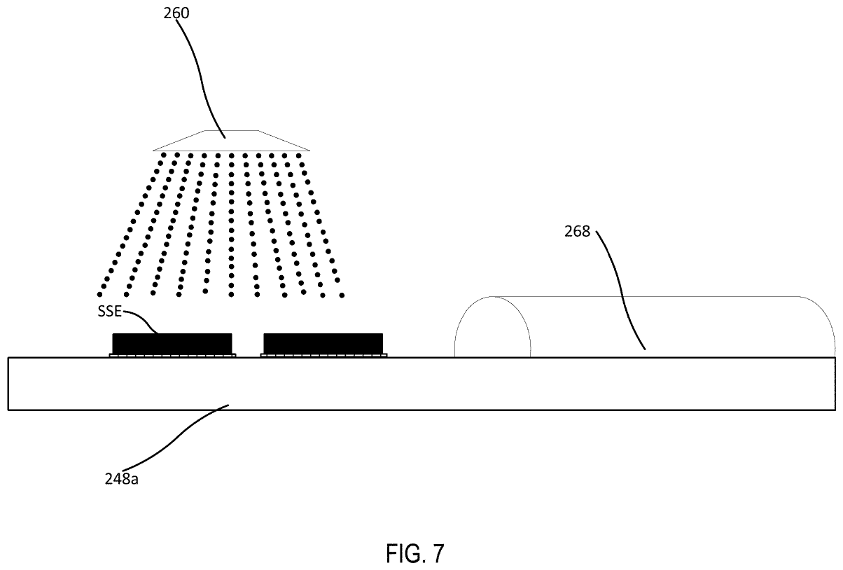

FIG. 7 is an illustration of a wetting device 260 and a tunnel 268, according to an embodiment. In some embodiments, the wetting device 260 and the tunnel 268 can be the same or substantially similar to the wetting device 160 and the tunnel 168, as described above with reference to FIG. 2. Thus, certain aspects of the wetting device 160 and the tunnel 168 are not described in greater detail herein. As shown, the wetting device 260 is a sprayer. In some embodiments, other wetting devices can be used, such as a hose or an ink jet. The wetting device 260 can dispense electrolyte or electrolyte solvent onto a semi-solid electrode being conveyed along the conveyor 248a. In some embodiments, the sprayed electrolyte or electrolyte solvent can replace solvent lost during other portions of the manufacturing process. The wetting with the electrolyte or electrolyte solvent can improve the electrochemical performance of the semi-solid electrode SSE and/or diffusivity within the SSE. The tunnel 268 can reduce solvent evaporation by limiting exposure to the outside atmosphere.

In some embodiments, the wetting device 260 can apply a liquid to the semi-solid electrode and/or the separator at a rate of at least about 0.5 mg/cm², at least about 1 mg/cm², at least about 1.5 mg/cm², at least about 2 mg/cm², or at least about 2.5 mg/cm². In some embodiments, the wetting device can apply a liquid to the semi-solid electrode and/or the separator at a rate of no more than about 3 mg/cm², no more than about 2.5 mg/cm², no more than about 2 mg/cm², no more than about 1.5 mg/cm², or no more than about 1 mg/cm². Combinations of the above-referenced amounts of liquid applied to the electrode and/or the separator are also possible (e.g., at least about 0.5 mg/cm² and no more than about 3 mg/cm² or at least about 1 mg/cm² and no more than about 2 mg/cm²), inclusive of all values and ranges therebetween. In some embodiments, the wetting device 260 can apply a liquid to the semi-solid electrode and/or the separator at a rate of about 0.5 mg/cm², about 1 mg/cm², about 1.5 mg/cm², about 2 mg/cm², about 2.5 mg/cm², or about 3 mg/cm².

In some embodiments, the wetting device 260 can apply a liquid to the semi-solid electrode and/or the separator at a rate of at least about 0.5 μL/cm², at least about 1 μL/cm², at least about 1.5 μL/cm², at least about 2 μL/cm², or at least about 2.5 μL/cm². In some embodiments, the wetting device can apply a liquid to the semi-solid electrode and/or the separator at a rate of no more than about 3 μL/cm², no more than about 2.5 μL/cm², no more than about 2 μL/cm², no more than about 1.5 μL/cm², or no more than about 1 μL/cm². Combinations of the above-referenced amounts of liquid applied to the electrode and/or the separator are also possible (e.g., at least about 0.5 μL/cm² and no more than about 3 μL/cm² or at least about 1 μL/cm² and no more than about 2 μL/cm²), inclusive of all values and ranges therebetween. In some embodiments, the wetting device 260 can apply a liquid to the semi-solid electrode and/or the separator at a rate of about 0.5 μL/cm², about 1 μL/cm², about 1.5 μL/cm², about 2 μL/cm², about 2.5 μL/cm², or about 3 μL/cm².

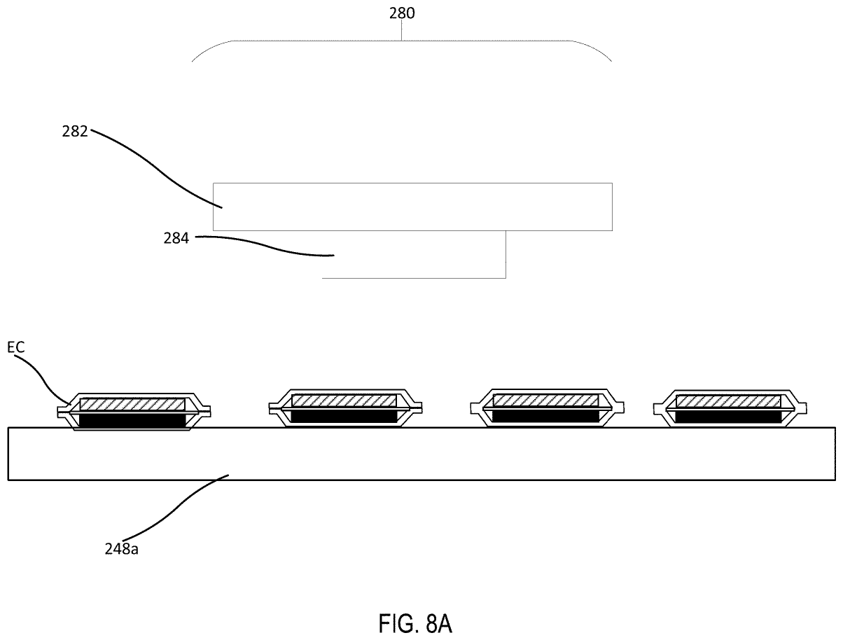

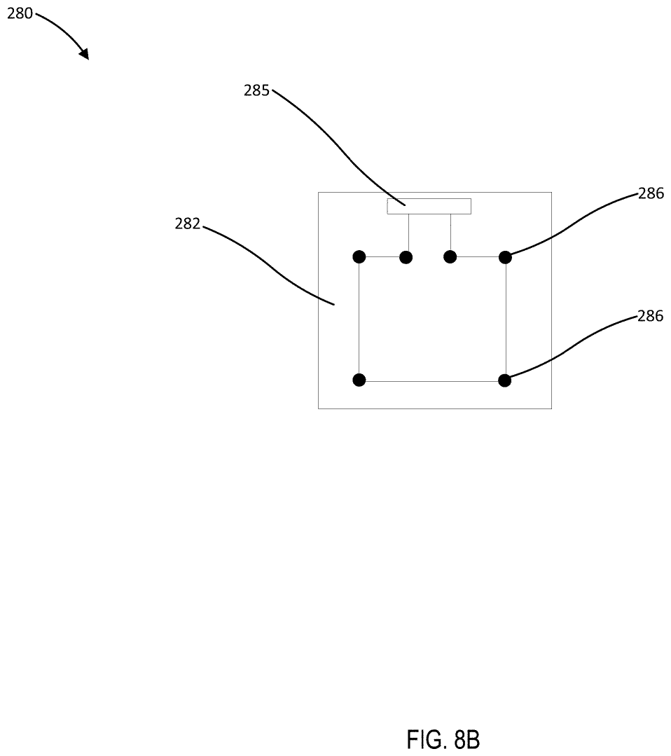

FIGS. 8A-8B show a pouch sealer 280, according to an embodiment. FIG. 8A shows a profile view of the pouch sealer 280, while FIG. 8B shows a bottom view of the pouch sealer 280. In some embodiments, the pouch sealer 280 can be the same or substantially similar to the pouch sealer 180, as described above with reference to FIG. 2. Thus, certain aspects of the pouch sealer 280 are not described in greater detail herein. As shown, the pouch sealer 280 includes a base 282, a heater frame 284, and a wire cartridge 285. In use, the base 282 moves toward an electrochemical cell EC while the electrochemical cell EC is being conveyed along the conveyor 248a. The heater frame 284 makes contact with the outer edges of the pouch material of the electrochemical cell EC while being heated via an impulse heater. This application of heat seals the outer edges of the pouch material in a single step. The base 282 is then raised and the heater frame 284 is removed from contact with the electrochemical cell EC. With the design of the heater frame 284 extending around the perimeter of the electrochemical cell EC, the heat sealing of the pouch material can be executed in a single step.

The heater frame 284 includes heating wire lining the outer perimeter of the heater frame 284. After a large number of heating cycles, the wire can become fatigued and unusable. The wire cartridge 285 allows for deployment of new wire to replace the worn wire. Once the wire becomes fatigued, the wire cartridge can dispense a length of new wire (e.g., via one or more wheels in contact with the new wire) from a first portion of the wire cartridge 285 and the worn wire can be fed back into the wire cartridge 285 at a second portion of the wire cartridge. This mechanism is analogous to an automatic plastic toilet seat changer.

Impulse heating of the wire of the heater frame 284 can cause the heater frame 284 to expand and/or move. In some embodiments, constraints 286 can be placed at various locations around the heater frame 284 to minimize movement of the heater frame 284 during impulse heating. In some embodiments, the constraints 286 can include pins welded to the heater frame 284 and/or the base 282.

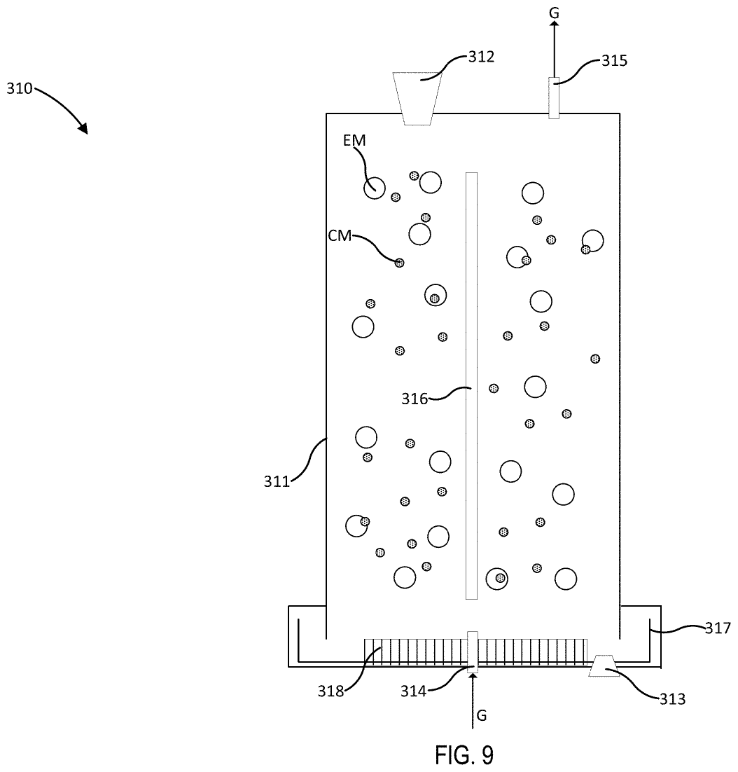

FIG. 9 is an illustration of a gravity dryer 310, according to an embodiment. As shown, the gravity dryer 310 includes a container 311, a powder loading port 312, a powder exhaust port 313, a gas inlet 314, a gas outlet 315, a vertical plate 316, a feeder tray 317, and a gas permeable floor 318. In some embodiments, the powder loading port 312, the powder exhaust port 313, the gas inlet 314, and the gas outlet 315 can be the same or substantially similar to the powder loading port 212, the powder exhaust port 231, the gas inlet 214, and the gas outlet 215, as described above with reference to FIG. 3. Thus, certain aspects of the powder loading port 312, the powder exhaust port 313, the gas inlet 314, and the gas outlet 315 are not described in greater detail herein. Active material AM and conductive material CM are shown passing through the gravity dryer 310, as well as gas G.

In some embodiments, the container 311 can have a cylindrical shape. A cylindrical shape and/or the inclusion of the vertical plate 316 can maintain a low but non-zero vertical solids stress on the powder inside the gravity dryer 310. Keeping a low, non-zero vertical solids stress on the powder inside the gravity dryer 310 can prevent the gas G from channeling. In other words, the gas G can begin to channel around the powder and not contribute to drying clusters of the powder. A cylindrical shape of the container 311 and/or the inclusion of the vertical plate 316 in the container 311 can aid in dispersion of the flow of the gas G to prevent channeling of the gas G and clustering of the powder.

The feeder tray 317 can be porous, such that the gas G flows through many pores on the feeder tray 317 into the container 311, rather than through a single orifice. The combination of the feeder tray 317 and the gas permeable floor 318 can aid in dispersing the gas G throughout the container 311. In some embodiments, the feeder tray 317 can have a circular shape.

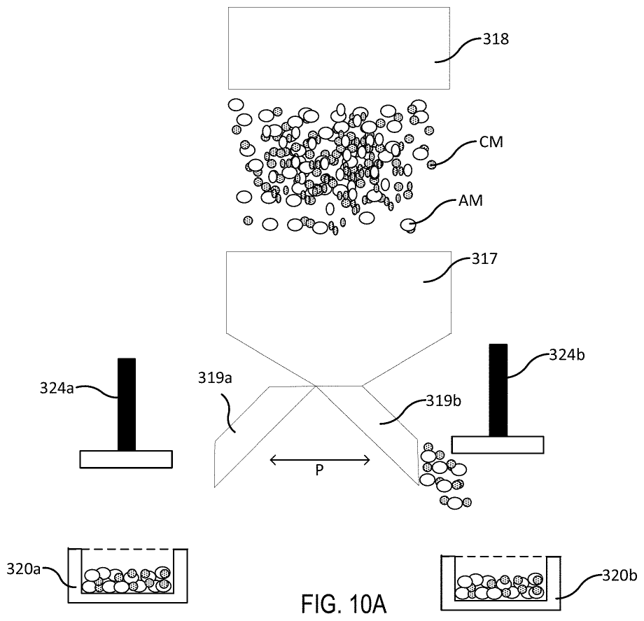

FIGS. 10A-10B are illustrations of components of a brick-forming system, according to an embodiment. FIG. 10A is a side view, while FIG. 10B is a top view of the components. As shown, the active material AM, the conductive material CM, and the electrolyte (not shown) pass from a mixer 318 to a hopper 317 after being mixed. In some embodiments, the mixer 318 can include a twin-screw extruder. In some embodiments, the mixer 318 can include a twin-screw kneader. From the hopper 317, the active material AM, the conductive material CM, and the electrolyte (active material AM, conductive material CM, and electrolyte collectively referred to herein as “semi-solid electrode material”) passes through feeder 319a and/or feeder 319b (collectively referred to as feeders 319) to compressor 320a and/or compressor 320b (collectively referred to as compressors 320). In some embodiments, the compressors 320 can be brick-forming chambers, wherein the semi-solid electrode material can be pressed to form a semi-solid electrode brick. Once the semi-solid electrode material is in the compressors 320, brick-forming presses 324a, 324b (collectively referred to as brick-forming presses 324). As shown, the feeders 319 are adjustable and can move along line P to align either the feeder 319a or the feeder 319b with the hopper 317. The semi-solid electrode material flows to the compressor 320a via the feeder 319a and/or to the compressor 320b via the feeder 319b. In some embodiments, the semi-solid electrode material in the compressor 320a can be pressed by the brick-forming press 324a. In some embodiments, the semi-solid electrode material in the compressor 320b can be pressed by the brick-forming press 324b.

In some embodiments, the semi-solid electrode material can be subject a conductivity test at conductivity test stations 325a, 325b (collectively referred to as conductivity test stations 325). In some embodiments, the conductivity test can be performed with the semi-solid electrode material in the compressors 320. In some embodiments, the semi-solid electrode material can be removed from the compressors 320 prior to the conductivity test. After being subject to the conductivity test, the semi-solid electrode material can be fed to the cartridges 330a, 330b (collectively referred to as cartridges 330). In some embodiments, the cartridges 330 can be the same or substantially similar to the cartridge 230, as described above with reference to FIG. 5. Thus, certain aspects of the cartridges 330 are not described in greater detail herein.

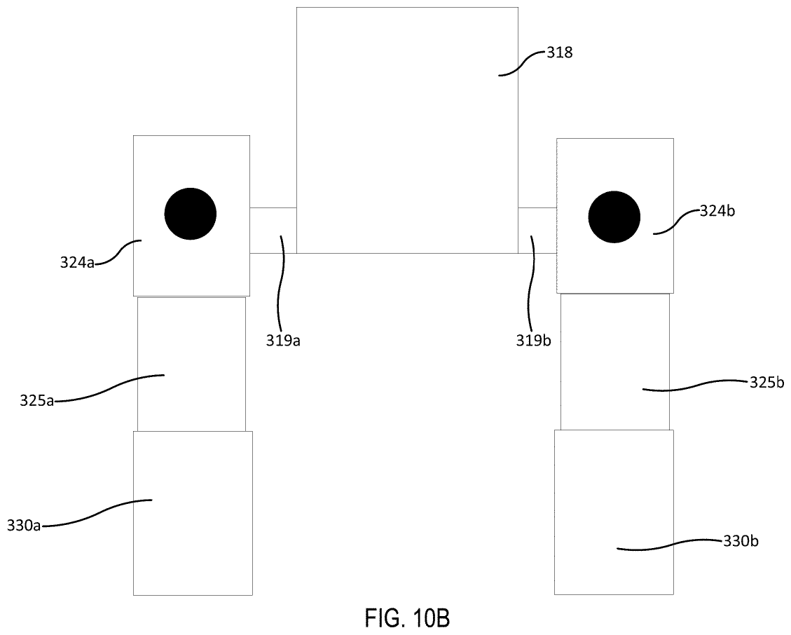

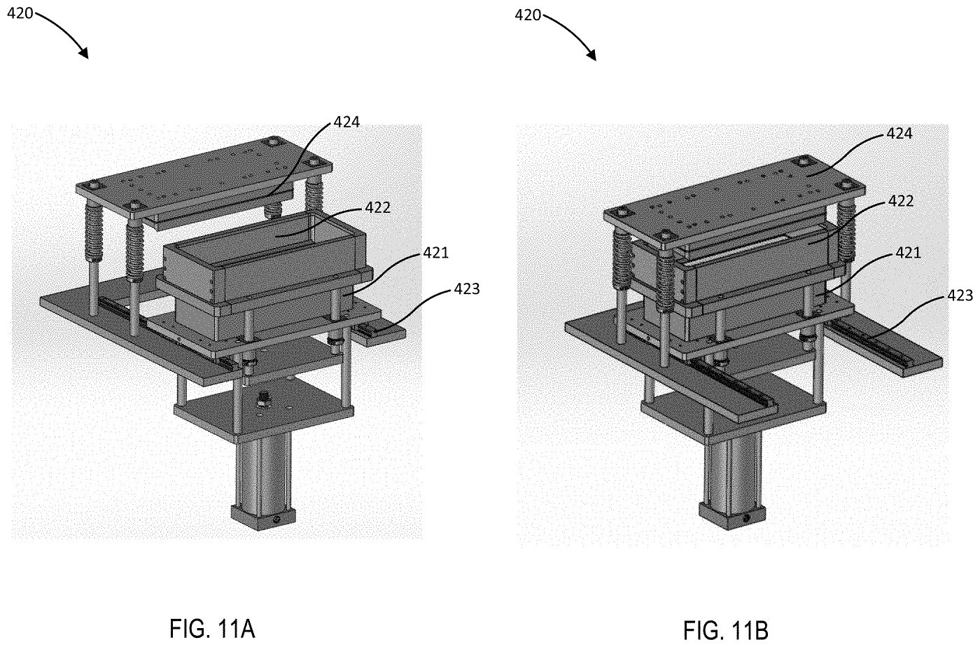

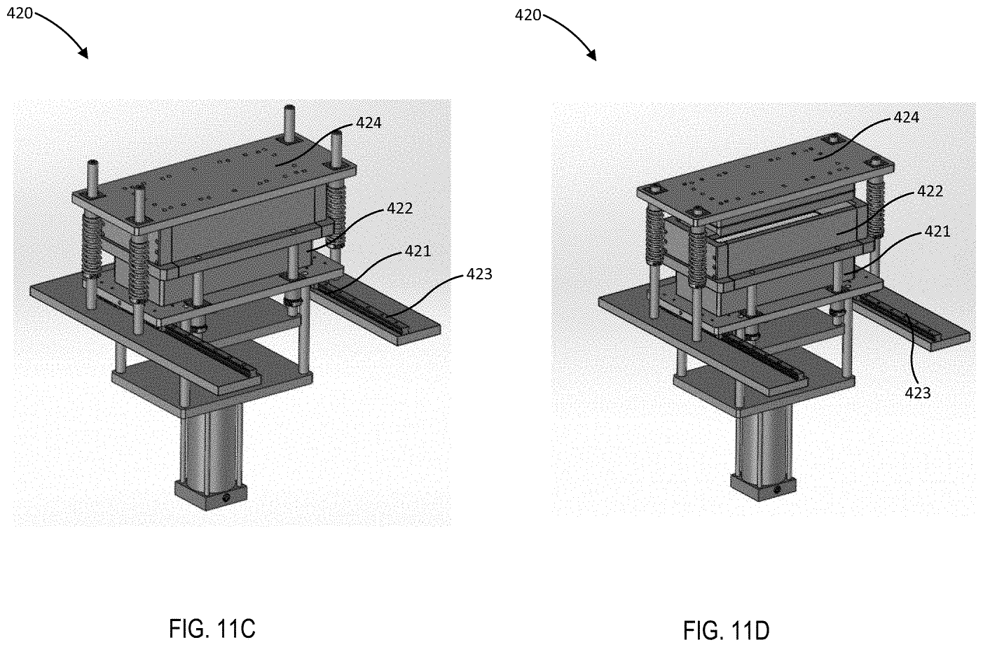

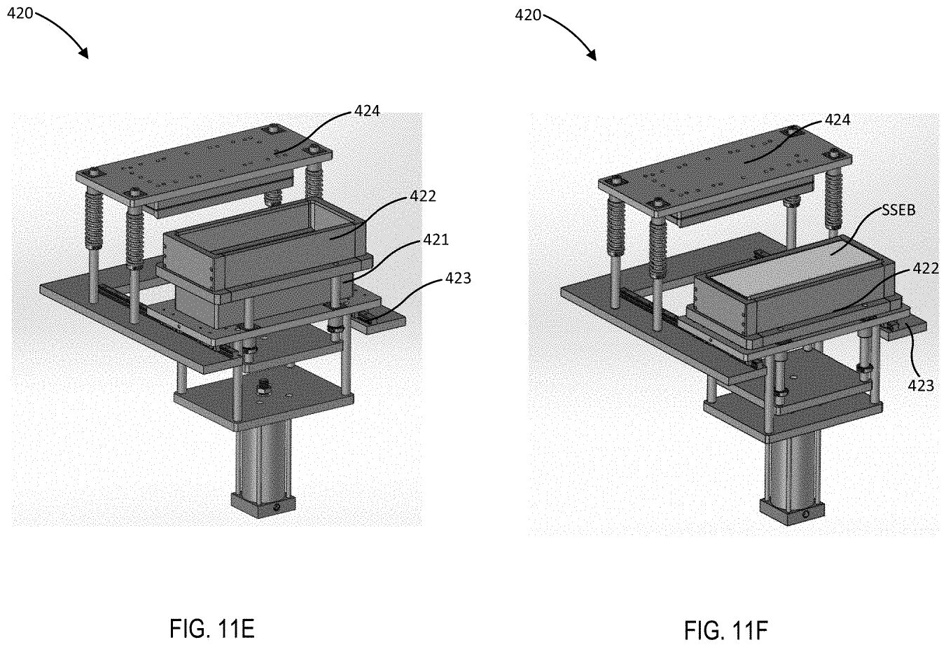

FIGS. 11A-11F are illustrations of a compressor 420, according to an embodiment. Each of FIGS. 11A-11F show different portions of the brick forming process. As shown, the compressor 420 includes a container base 421, a container jacket 422, a sliding platform 423, and a piston 424. In some embodiments, the container jacket 422 and the piston 424 can be the same or substantially similar to the container 222 and the piston 224, as described above with reference to FIG. 4. Thus, certain aspects of the container jacket 422 and the piston 424 are not described in greater detail herein.

In use, as shown in FIG. 11A, the container jacket 422 is lifted. The container base 421 and the container jacket 422 are moved to a forward position along the sliding platform 423. While the container base 421 and the container jacket 422 are in the forward position, semi-solid electrode material can be loaded into the container jacket 422. In some embodiments, the forward position can be away from the piston 424 such that the piston 424 does not interfere with the loading of the semi-solid electrode material. The semi-solid electrode material is then loaded into the container jacket 422. After the semi-solid electrode material is loaded into the container jacket 422, the container base 421 and the container jacket 422 are slid into a back position along the sliding platform 423, as shown in FIG. 11B. In some embodiments, the back position can place the container base 421 and the container jacket 422 such that they are directly underneath the piston 424. After the container base 421 and the container jacket 422 are placed under the piston 424, the piston 424 is lowered, as shown in FIG. 11C. The piston 424 compresses the semi-solid electrode material to form a semi-solid electrode brick SSEB.

After the piston 424 has compressed the semi-solid electrode material to form the semi-solid electrode brick SSEB, the piston 424 is raised, as shown in FIG. 11D. After the piston 424 is raised, the container base 421 and the container jacket 422 are moved to the forward position along the sliding platform 423, as shown in FIG. 11E. The container jacket 422 is then lowered along an outside perimeter of the container base 421 to expose the semi-solid electrode brick SSEB, as shown in FIG. 11F. The semi-solid electrode brick SSEB can then be removed from the compressor 420 and placed into a cartridge (not shown).

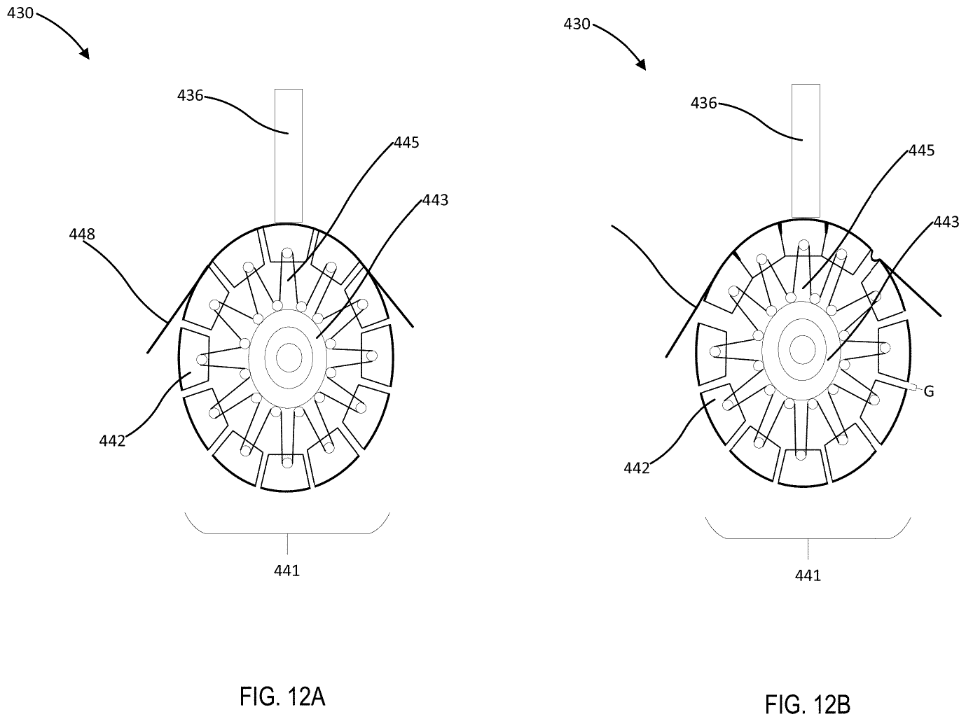

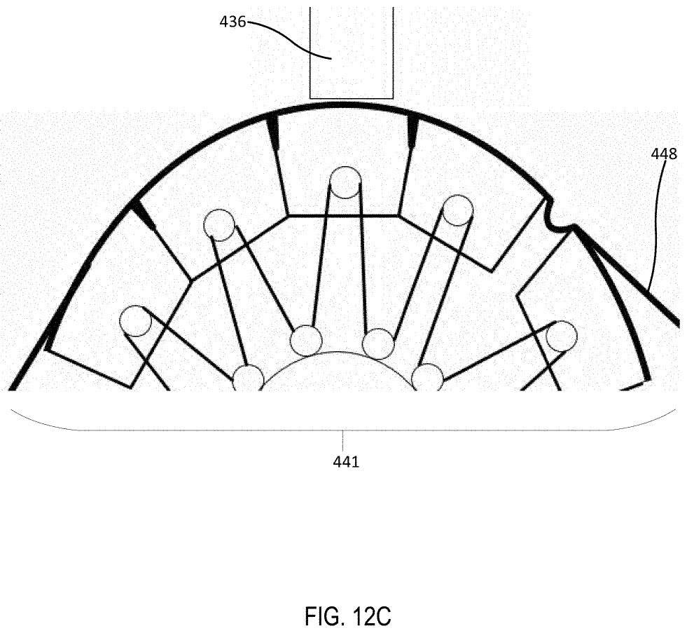

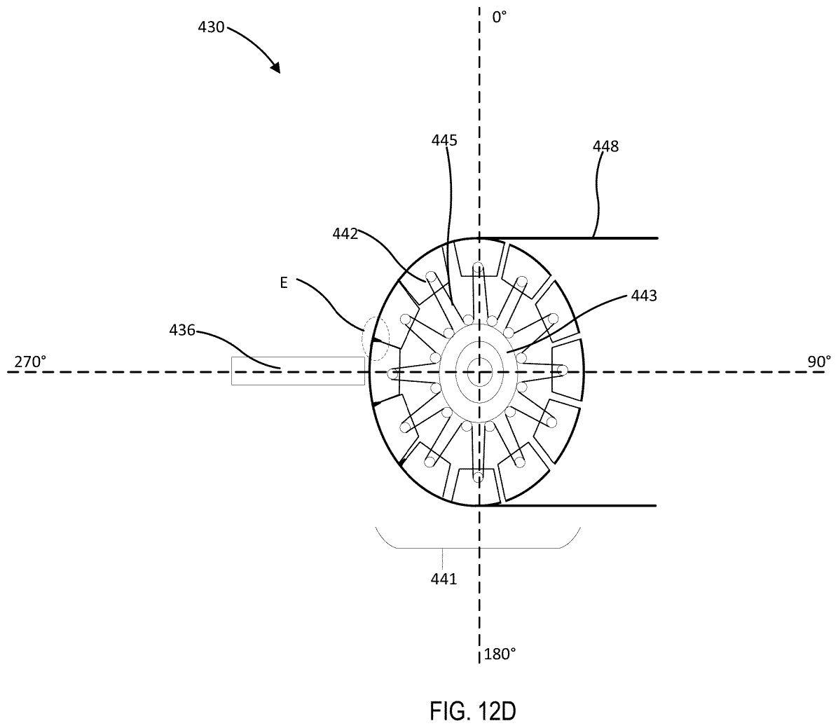

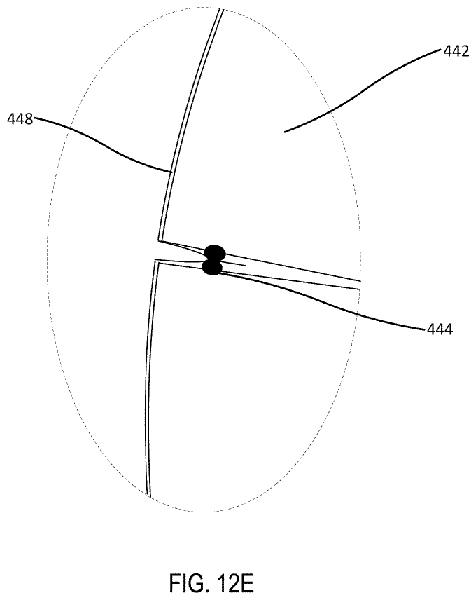

FIGS. 12A-12E are illustrations of an extrusion system 430, according to an embodiment. As shown, the extrusion system 430 includes a dispenser 436 (e.g., a nozzle) and a rotating drum 441. The rotating drum 441 includes a plurality of pallets 442. The pallets 442 are coupled to a plate cam 443 via cam levers 445. In some embodiments, the plate cam 443 and the cam levers 445 rotate about a static anvil drum. The static anvil drum can be at or near the center of the rotating drum 441. A conveyor 448 is shown in contact with one or more of the pallets 442. FIG. 12A shows the pallets 442 near the dispenser 436 in an open position while FIG. 12B shows the pallets 442 near the dispenser 436 in a closed position. In use, a film and/or current collector material (not shown) can be placed on the conveyor 448 and advanced along the pallets 442 via the rotating drum 441. In some embodiments, a film and/or current collector material can act as the conveyor 448. In other words, the film and/or current collector material can move around the outside edge of the rotating drum 441 in the absence of a conveyor belt or other conveying device below the film and/or current collector. In some embodiments the film can be conveyed around the outside edge of the rotating drum 441. In some embodiments, the current collector material can be conveyed around the outside edge of the rotating drum 441. In some embodiments, the film and the current collector material can be conveyed around the outside edge of the rotating drum 441. By adjusting the pallets 442 from the open position to the closed position, the current collector can be pinched such that a portion of the film and/or current collector material is pinched between pallets 442. Semi-solid electrode material (not shown) can be dispensed from the dispenser 436 onto the current collector material. Upon advancement via the rotating drum 441, the pallets 442 can be separated again, leaving a current collector material with semi-solid electrodes separated from one another. In some embodiments, the pallets 442 can be attached or keyed together to absorb moments. In other words, the pallets 442 can collectively absorb a shock, rather than one pallet absorbing the shock. In some embodiments, the outer surface of the pallets 442 can be cylindrically precision ground.

In some embodiments, the cam levers 445 can control the positioning and timing of the pallets 442. In some embodiments, a pallet vacuum and/or chilled water can be fed through a multiple pass rotary union inside the rotating drum 441. In some embodiments, the pallets 442 can be ground on the rotating drum 441 to ensure height accuracy. In some embodiments, the position of each of the pallets 442 can be controlled by the plate cam 445 and cam levers 443, removing cumulative stack up error. In some embodiments, a film tucking mechanism can be included to synchronously tuck the current collector material and/or film between the pallets 442. In some embodiments, cylindrical supports provide stiffness to the pallets 442.

The size and breadth of the rotating drum 441 can make the rotating drum 441 robust and resistant to movement and deflection from outside forces (e.g., from casting or densification instrumentation) than a linear conveyance device (e.g., a flat belt). Additionally, the arch shape formed by adjacent pallets 442 can create a structural stability in the rotating drum 441 that can resist deflection. The anvil drum in the center of the rotating drum 441 can have a cylindrical shape, offering additional resistance to outside forces. Casting from the dispenser 436 can exert a substantial force (e.g., about 10 kN, about 20 kN, about 30 kN, about 40 kN, about 50 kN, about 60 kN, about 70 kN, about 80 kN, about 90 kN, or about 100 kN, inclusive of all values and ranges therebetween), and a conveyance device with a broad base can withstand a large amount of force. In some embodiments, the rotating drum 441 can have a diameter of at least about 5 cm, at least about 10 cm, at least about 15 cm, at least about 20 cm, at least about 25 cm, at least about 30 cm, at least about 35 cm, at least about 40 cm, at least about 45 cm, at least about 50 cm, at least about 55 cm, at least about 60 cm, at least about 65 cm, at least about 70 cm, at least about 75 cm, at least about 80 cm, at least about 85 cm, at least about 90 cm, at least about 95 cm, at least about 1 m, at least about 2 m, at least about 3 m, at least about 4 m, at least about 5 m, at least about 6 m, at least about 7 m, at least about 8 m, or at least about 9 m. In some embodiments, the rotating drum 441 can have a diameter of no more than about 10 m, no more than about 9 m, no more than about 8 m, no more than about 7 m, no more than about 6 m, no more than about 5 m, no more than about 4 m, no more than about 3 m, no more than about 2 m, no more than about 1 m, no more than about 95 cm, no more than about 90 cm, no more than about 85 cm, no more than about 80 cm, no more than about 75 cm, no more than about 70 cm, no more than about 65 cm, no more than about 60 cm, no more than about 55 cm, no more than about 50 cm, no more than about 45 cm, no more than about 40 cm, no more than about 35 cm, no more than about 30 cm, no more than about 25 cm, no more than about 20 cm, no more than about 15 cm, or no more than about 10 cm.

Combinations of the above-referenced diameters of the rotating drum 441 are also possible (e.g., at least about 5 cm and no more than about 10 m or at least about 20 cm and no more than about 40 cm), inclusive of all values and ranges therebetween. In some embodiments, the rotating drum 441 can have a diameter of about 5 cm, about 10 cm, about 15 cm, about 20 cm, about 25 cm, about 30 cm, about 35 cm, about 40 cm, about 45 cm, about 50 cm, about 55 cm, about 60 cm, about 65 cm, about 70 cm, about 75 cm, about 80 cm, about 85 cm, about 90 cm, about 95 cm, about 1 m, about 2 m, about 3 m, about 4 m, about 5 m, about 6 m, about 7 m, about 8 m, about 9 m, or about 10 m.

The robustness of the rotating drum 441 can aid in improving uniformity among electrodes produced. More specifically, the rotating drum 441 resists movement from the force of the casting. This resistance to movement can reduce the margin of error of the thickness of the electrode material when cast onto the conveyor 448. In other words, the deviation in thickness from one electrode to the next can be minimized. In some embodiments, the robustness of the rotating drum 441 and the uniformity of electrode thickness the rotating drum 441 affords can obviate a thickness inspection method (e.g., X-ray inspection) from the electrode production process. Keying or connecting the pallets 442 together can also improve this robustness. In some embodiments, the pallets 442 can be cylindrically ground to form the rotating drum 441. Upon manufacturing, the pallets 442 may have slight deviations in size from one pallet to another. The pallets 442 can be placed onto the plate cams 445, and then the rotating drum 441 can be cylindrically grinded to smooth the outer surface of the pallets 442. The smoothness of the outer surface of the pallets 442 can further improve uniformity of the electrodes cast onto the conveyor 448.

As shown, a gap G can be measured between the edges of adjacent pallets 442. In some embodiments, when the adjacent pallets 442 are not being pressed together, the gap G can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, when the adjacent pallets 442 are not being pressed together, the gap G can be no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced values of the gap G when the adjacent pallets 442 are not being pressed together are also possible (e.g., at least about 10 μm and no more than about 1 cm or at least about 100 μm and no more than about 1 mm), inclusive of all values and ranges therebetween. In some embodiments, when the adjacent pallets 442 are not being pressed together, the gap G can be about 10 μm, about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1 mm, about 2 mm, about 3 mm, about 4 mm, about 5 mm, about 6 mm, about 7 mm, about 8 mm, about 9 mm, or about 1 cm.

In some embodiments, when the adjacent pallets 442 are pressed together, the gap G can be no more than about 2 mm, no more than about 1 mm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, or no more than about 1 μm.

In some embodiments, the rotating drum 441 can rotate at a rotational velocity of at least about 10 rpm, at least about 20 rpm, at least about 30 rpm, at least about 40 rpm, at least about 50 rpm, at least about 60 rpm, at least about 70 rpm, at least about 80 rpm, at least about 90 rpm, at least about 100 rpm, at least about 150 rpm, at least about 200 rpm, at least about 250 rpm, at least about 300 rpm, at least about 350 rpm, at least about 400 rpm, at least about 450 rpm, or at least about 500 rpm, inclusive of all values and ranges therebetween.

In some embodiments, the rotating drum 441 can include a vacuum therein, such that the vacuum can pull and tuck portions of the conveyor 448 (and current collector material disposed thereon) into the rotating drum 441, as shown in FIG. 12C. The vacuum tucking can pull portions of the conveyor 448 and the current collector material thereon inward to facilitate tucking of the current collector. Inducing tucking from within the rotating drum 441 can aid in preventing contamination of the electrode material dispensed on the current collector material. More specifically, a tucking arm or a tucking finger, if not timed just right, can contact electrode material disposed on the current collector material. This electrode material can become deposited on the tucking arm or the tucking finger. This deposited electrode material can contaminate later electrode materials that pass over the rotating drum 441. Including a vacuum in the rotating drum 441 can prevent a piece of material from contacting and contaminating other materials. Additionally, the vacuum inside the rotating drum 441 can aid in tucking the conveyor 448 and the current collector material deeper than a tucking arm or a tucking finger. The rotating drum 441 can move at high speeds (e.g., about 30 rpm, about 40 rpm, about 50 rpm, about 60 rpm, about 70 rpm, about 80 rpm, about 90 rpm, or about 100 rpm, inclusive of all values and ranges therebetween). These high speeds can make it difficult for a tucking arm or a tucking finger to precisely target and penetrate the spaces between the pallets 442 deeply enough such that the conveyor 448 and the current collector are fully tucked between the pallets.

In some embodiments, the tucking of the conveyor 448 can be time-staggered. In other words, the plate cams 445 can cause gaps to open and close between the pallets 442 over a relatively long time period. More specifically, two adjacent pallets 442 can travel around a significant portion of the outside edge of the rotating drum 441 while coupled together, before separating from each other. This time-staggered approach can allow for a longer period of time for the electrode material to be dispensed onto a tucked current collector material than if the pallets are simply tucked for a brief period of time (e.g., the length of time the rotating drum 441 needs to travel a distance of the width of one pallet 442). In some embodiments, adjacent pallets 442 can be coupled together for at least about 10%, at least about 15%, at least about 20%, at least about 25%, at least about 30%, at least about 35%, at least about 40%, at least about 45%, or at least about 50% of a full rotation around the center of the rotating drum 441. In some embodiments, one or more barrel cams can be used to execute the time-staggered tucking of the conveyor 448.

As shown in FIGS. 12A-12C, the dispenser 436 casts the electrode material vertically. In other words, the dispenser 436 casts in a direction perpendicular to the ground when the conveyor 448 is near its highest point on the rotating drum. In some embodiments, the dispenser 436 can cast horizontally (i.e., in a direction parallel to the ground). In some embodiments, the dispenser 436 can cast horizontally on a side of the conveyor 448, as shown in FIG. 12D. FIG. 12D shows angles relative to the vertical plane at the top of the rotating drum 441, for reference (0 degrees, 90 degrees, 180 degrees, 270 degrees. In some embodiments, the dispenser 436 can cast at an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 230 degrees, about 235 degrees, about 240 degrees, about 245 degrees, about 250 degrees, about 255 degrees, about 260 degrees, about 265 degrees, about 270 degrees, about 275 degrees, about 280 degrees, about 285 degrees, about 290 degrees, about 295 degrees, about 300 degrees, about 305 degrees, about 310 degrees, about 315 degrees, about 320 degrees, about 325 degrees, about 330 degrees, about 335 degrees, about 340 degrees, about 345 degrees, about 350 degrees, or about 355 degrees relative to the vertical plane at the top of the rotating drum 441, inclusive of all values and ranges therebetween.

In some embodiments, the dispenser 436 can move to control casting gaps between the dispenser 436 and the conveyor 448 to a precision of less than 10 μm, less than 9 μm, less than 8 μm, less than 7 μm, less than 6 μm, less than 5 μm less than 4 μm, less than 3 μm, less than 2 μm, or less than 1 μm. In some embodiments, the gap between the dispenser 436 and the conveyor 448 can be adjusted (e.g., via a computer algorithm controlling movement of the dispenser 436) at distance intervals traveled by the conveyor 448. For example, the dispenser 436 can be adjusted once for every 10 mm the conveyor 448 travels. These quick adjustments can aid in creating uniformity in the thickness of resulting electrodes. In some embodiments, the position of the dispenser 448 relative to the can be adjusted once for about every 1 mm, about every 2 mm, about every 3 mm, about every 4 mm, about every 5 mm, about every 6 mm, about every 7 mm, about every 8 mm, about every 9 mm, about every 10 mm, about every 11 mm, about every 12 mm, about every 13 mm, about every 14 mm, about every 15 mm, about every 16 mm, about every 17 mm, about every 18 mm, about every 19 mm, about every 20 mm, about every 25 mm, about every 25 mm, about every 30 mm, about every 35 mm, about every 40 mm, about every 45 mm, or about every 50 mm the conveyor 448 travels, inclusive of all values and ranges therebetween.

As shown in FIG. 12D, the conveyor 448 circumnavigates around the outside edge of the rotating drum 441. In some embodiments, the conveyor 448 can have a current collector material (not shown) disposed thereon. In some embodiments, the current collector material can circumnavigate around the outside edge of the rotating drum 441 without the conveyor 448.

As shown in FIG. 12D, the conveyor 448 enters the rotating drum 441 at the bottom of the drum (i.e., at about 180 degrees, relative to the vertical plane at the top of the rotating drum 441). In some embodiments, the conveyor 448 can enter the rotating drum 441 at an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 230 degrees, about 235 degrees, about 240 degrees, about 245 degrees, about 250 degrees, about 255 degrees, about 260 degrees, about 265 degrees, about 270 degrees, about 275 degrees, about 280 degrees, about 285 degrees, about 290 degrees, about 295 degrees, about 300 degrees, about 305 degrees, about 310 degrees, about 315 degrees, about 320 degrees, about 325 degrees, about 330 degrees, about 335 degrees, about 340 degrees, about 345 degrees, about 350 degrees, or about 355 degrees relative to the vertical plane at the top of the rotating drum 441, inclusive of all values and ranges therebetween.

As shown in FIG. 12D, the conveyor 448 exits the rotating drum 441 at the top of the drum (i.e., at about 0 degrees, relative to the vertical plane at the top of the rotating drum 441). In some embodiments, the conveyor 448 can exit the rotating drum 441 at an angle of about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, about 200 degrees, about 205 degrees, about 210 degrees, about 215 degrees, about 220 degrees, about 225 degrees, about 230 degrees, about 235 degrees, about 240 degrees, about 245 degrees, about 250 degrees, about 255 degrees, about 260 degrees, about 265 degrees, about 270 degrees, about 275 degrees, about 280 degrees, about 285 degrees, about 290 degrees, about 295 degrees, about 300 degrees, about 305 degrees, about 310 degrees, about 315 degrees, about 320 degrees, about 325 degrees, about 330 degrees, about 335 degrees, about 340 degrees, about 345 degrees, about 350 degrees, or about 355 degrees relative to the vertical plane at the top of the rotating drum 441, inclusive of all values and ranges therebetween.

As shown in FIG. 12D, the conveyor 448 exits the rotating drum 441 about 180 degrees from where it entered the rotating drum 441. In other words, the conveyor 448 contacts or osculates the rotating drum 441 for about 180 degrees. In some embodiments, the conveyor 448 can contact the rotating drum 441 for about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, about 120 degrees, about 125 degrees, about 130 degrees, about 135 degrees, about 140 degrees, about 145 degrees, about 150 degrees, about 155 degrees, about 160 degrees, about 165 degrees, about 170 degrees, about 175 degrees, about 180 degrees, about 185 degrees, about 190 degrees, about 195 degrees, or about 200 degrees, inclusive of all values and ranges therebetween.

The entry point of the conveyor 448 can be selected such that the conveyor 448 have enough space to flatten onto the outside surface of the pallets 442. Additionally, the greater the angle between the entry point and the exit point of the conveyor 448, the more space (and therefore time) the dispenser 436 has to cast the electrode material onto the conveyor 448. As shown, one dispenser 436 is casting electrode material onto the conveyor 448. In some embodiments, the extrusion system 430 can include multiple dispensers casting electrode material onto the conveyor 448.

FIG. 12D includes a section E, which is shown in greater detail in FIG. 12E. FIG. 12E shows a close-up view of two pallets 442 pressed together and pinching the conveyor 448. As shown, the conveyor 448 is tucked between the pallets 442. Each of the pallets 442 includes gaskets or deformable members 444 disposed on the outside edges of the pallets 442. The gaskets 444 can increase friction between adjacent pallets 442 in order to prevent the pallets 442 from sliding relative to each other. In some embodiments, the pallets 442 can be composed of stainless steel, aluminum, or similar metals or materials with smooth surfaces. If the smooth surfaces of the pallets 442 contact each other, they can move laterally (i.e., toward the center of the rotating drum 441 and away from the center of the rotating drum 441), relative to each other. In other words, the gaskets 444 prevent metal-to-metal contact and the sliding that can result therefrom. Additionally, the gaskets 444 can ensure that the pallets 442 are gripping the conveyor 448, current collector, and/or any film material being conveyed around the rotating drum 441 along the entire depth of the pallets 444. In some embodiments, the gaskets 444 can include O-rings. In some embodiments, the gaskets 444 can be composed of a deformable material, an elastomeric material, natural rubber, silicone rubber, neoprene rubber, neoprene sponge, cork, or any combination thereof. In some embodiments, the gaskets 444 can include a seal or a sealing member. This can prevent leaks of electrolyte or semi-solid electrode material into the pinched portion of the current collector and/or film material during production, while metal-to-metal contact may not be as thorough.

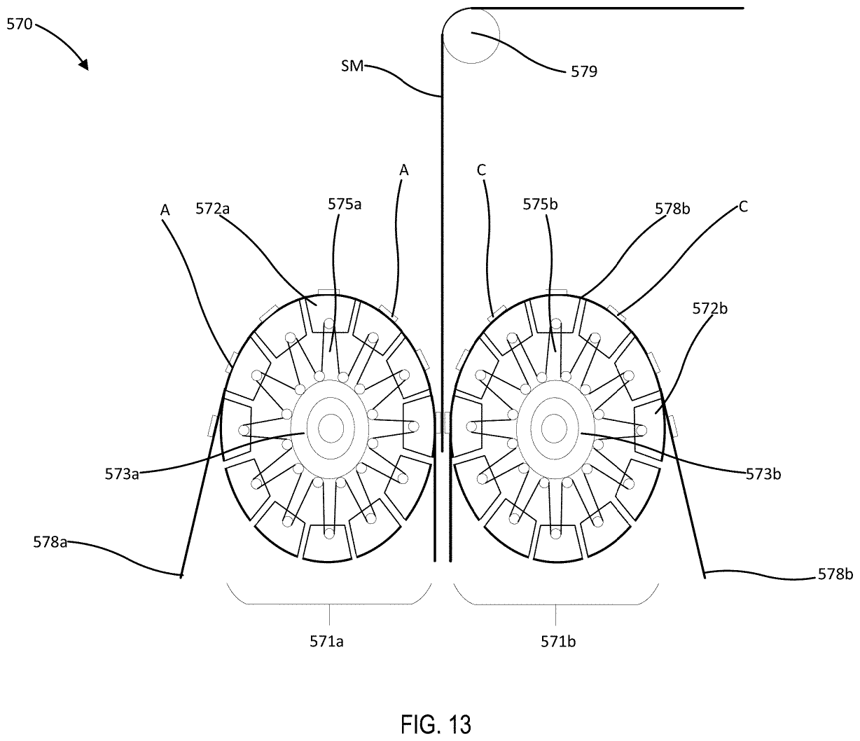

FIG. 13 shows an adjoining system 570 with a set of rotating drums 571a, 571b for assembly of an electrochemical cell, according to an embodiment. FIG. 13 depicts an anode rotating drum 571a and a cathode rotating drum 571b. As shown, the anode rotating drum 571a includes pallets 572a, cam levers 573a, plate cams 575a, and a conveyor 578a with anodes A disposed thereon. As shown, the cathode rotating drum 571b includes pallets 572b, cam levers 573b, plate cams 575b, and a conveyor 578b with cathodes C disposed thereon. A separator material SM is dispensed between the anodes A and the cathodes C. The separator material SM is facilitated via a separator roller. In some embodiments, the rotating drums 571a, 571c, the pallets 572a, 572b, the cam levers 573a, 573b, the plate cams 575a, 575b, and the conveyors 578a, 578b can be the same or substantially similar to the rotating drum 441, the pallets 442, the cam levers 443, the plate cams 445, and the conveyors 448, as described above with reference to FIGS. 12A-12C. Thus, certain aspects of the rotating drums 571a, 571c, the pallets 572a, 572b, the cam levers 573a, 573b, the plate cams 575a, 575b, and the conveyors 578a, 578b are not described in greater detail herein. In some embodiments, casting can be performed on the rotating drums 571a, 571b. In some embodiments, casting can be performed on one or more different rotating drums from the rotating drums 571a, 571b.

As shown, the anodes A and the cathodes C are aligned with a portion of the separator material SM disposed therebetween. The cam levers 573a, 573b and the plate cams 575a, 575b can induce movements of the pallets 572a, 572b relative to the rest of the rotating drums 571a, 571b, such that the anodes A and the cathodes C can line up properly. This increases the margin of error for casting of the anodes A onto the pallets 572a and the cathodes C onto the pallets 572c. In other words, if the current collector material (not shown) on which the anodes A and the cathodes C are placed are moving out of phase with each other, the movement of the pallets 572a, 572b can aid in correcting this discrepancy. More specifically, errors in timing of dispensing the anodes A and the cathodes C can be compensated by inducing movements in the pallets 572a, 572b, such that the anodes A and the cathodes C can line up properly when producing the electrochemical cell. In some embodiments, the anode rotating drum 571a and/or the cathode rotating drum 571b can include a vacuum disposed therein. In some embodiments, the vacuum can aid in tucking the current collector material between the pallets 572a, 572b. In some embodiments, the vacuum can perpetuate movement of the pallets 572a, 572b, relative to the rest of the rotating drums 571a, 571b. In other words, an inward force exerted on the conveyors 578a and the current collector material disposed thereon can exert a force on the pallets 572a on the rotating drum 571a and push them apart from each other. Similarly, an inward force exerted on the conveyors 578b and the current collector material disposed thereon can exert a force on the pallets 572b on the rotating drum 571b and push them apart from each other.

In some embodiments, the movements of the pallets 572a, 572b can align the anodes A and the cathodes C in the formed electrochemical cell to a margin of error of less than about 1 mm. In other words, a center line running through the anode A can be less than about 1 mm from a center line running through the cathode C. In some embodiments, the margin of error can be less than about 900 μm, less than about 800 μm, less than about 700 μm, less than about 600 μm, less than about 500 μm, less than about 400 μm, less than about 300 μm, less than about 200 μm, or less than about 100 μm, inclusive of all values and ranges therebetween.

In some embodiments, fiducials or reference marks can be added to the anodes A, the cathodes C, the current collector material, and/or the film. The use of fiducials can aid in easing the alignment process of the anodes A and the cathodes C. For example, an imaging device (e.g., X-ray, CT machine, ultrasound) can detect fiducials on the anodes A and the cathodes C and can communicate with the plate cams 575a, 575b to adjust their positioning so that the anodes A and the cathodes C line up properly when brought together to form the electrochemical cell. Fiducials can also allow for a single-side inspection of completed electrochemical cells or completed electrodes with multiple layers. For example, if a current collector of a completed electrochemical cell has a fiducial visible on the outside, inspection of that fiducial can be sufficient to confirm proper alignment of the electrodes and other components of the electrochemical cell, because they would have been aligned earlier in the production process.

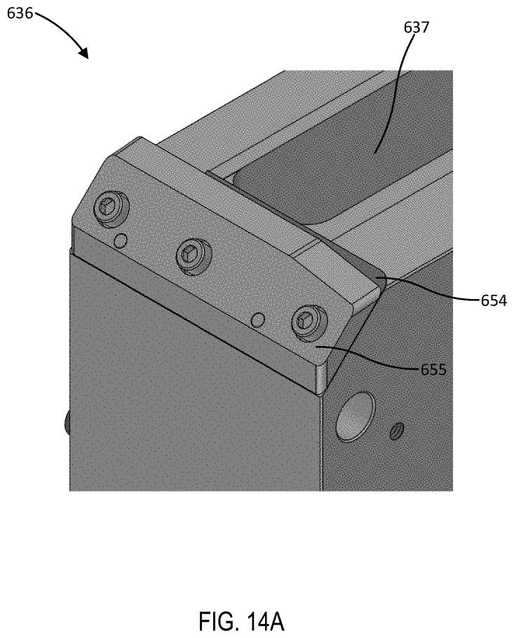

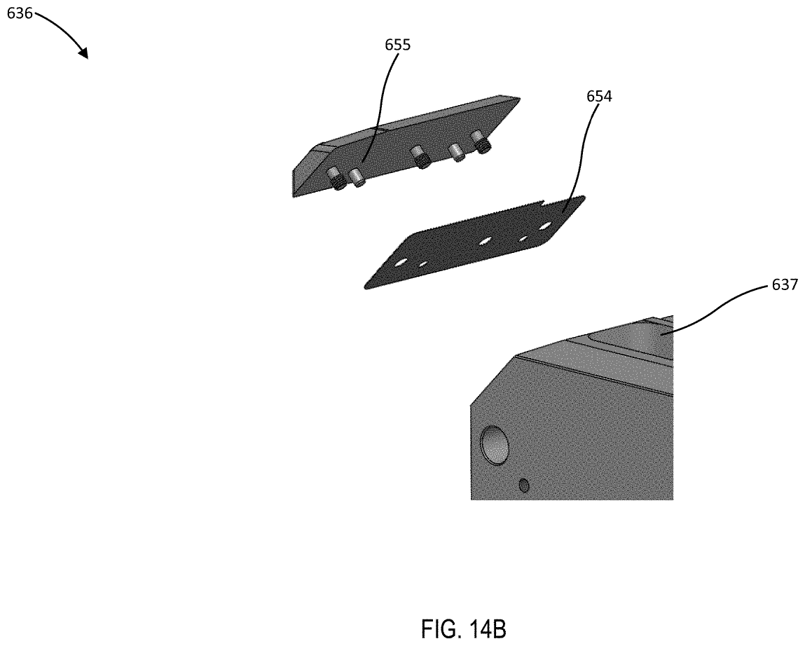

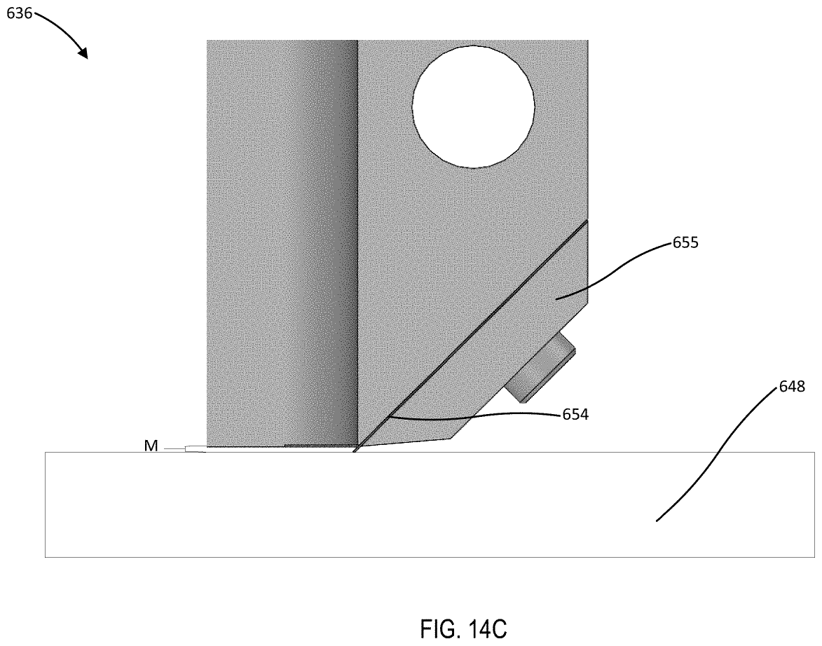

FIGS. 14A-14C show a nozzle 636, and various components thereof, according to an embodiment. The nozzle 636 includes a nozzle opening 637, a side plate 654, and a clamp 655. In some embodiments, the nozzle opening 637 and the side plate 654 can be the same or substantially similar to the nozzle opening 237 and the side plates 254, as described above with reference to FIG. 5. Thus, certain aspects of the nozzle opening 637 and the side plate 654 are not described in greater detail herein. FIG. 14A shows a view of a corner of the nozzle 636 with the side plate 654 affixed thereto via the clamp 655. FIG. 14B shows an exploded view of the side plate 654 and the clamp 655 detached from the nozzle 636. FIG. 14C shows a side view of the nozzle 636, showing the side plate 634 making contact with and applying a force to the conveyor 648, thereby forming a seal to prevent escape of semi-solid electrode material out the side of the nozzle 636.

As shown in FIG. 14C, the side plate 654 extends beyond a bottom edge of the nozzle 636 by a margin M. In some embodiments, the margin M can be at least about 0.5 mm, at least about 0.6 mm, at least about 0.7 mm, at least about 0.8 mm, or at least about 0.9 mm. In some embodiments, the margin M can be no more than about 1 mm, no more than about 0.9 mm, no more than about 0.8 mm, no more than about 0.7 mm, or no more than about 0.6 mm. Combinations of the above-referenced ranges for the margin M are also possible (e.g., at least about 0.5 mm and no more than about 1 mm or at least about 0.6 mm and no more than about 0.8 mm), inclusive of all values and ranges therebetween. In some embodiments, the margin M can be about 0.5 mm, about 0.6 mm, about 0.7 mm, about 0.8 mm, about 0.9 mm, or about 1 mm.

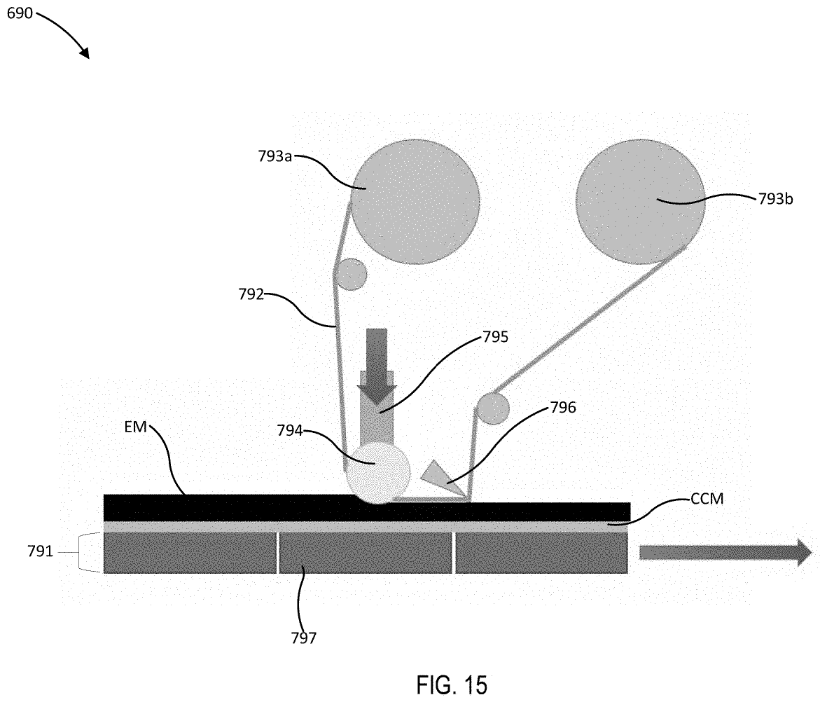

FIG. 15 is an illustration of a densification station 790, according to an embodiment. In some embodiments, the densification station 790 can employ any of the electrode densification methods described in the '192 publication. As shown, the densification station 790 includes a conveyor 791 with pallets 797, an absorptive material 792, material spools 793a, 793b (collectively referred to as material spools 793), a contact spool 794, a contact spool press 795, and a tucking arm 796. In use, an electrode material EM is conveyed along the conveyor 791 while the absorptive material 792 is propelled adjacent to the conveyor 791 and in contact with the electrode material EM. As shown, the electrode material EM is disposed on a current collector material CCM. In some embodiments, the current collector material CCM is disposed on a film (not shown). The absorptive material 792 is fed from the material spool 793a and is received by the material spool 793b. The absorptive material 792 contacts the contact spool 794 and the tucking arm 796. The contact spool 794 is positioned above the conveyor 791 to place the absorptive material 792 in contact with the electrode material EM. A portion of the liquid in the electrode material EM transfers to the absorptive material 792. The contact spool press 795 can adjust the position of the contact spool 794 in relation to the conveyor. For example, if a larger amount of densification and/or liquid absorption is desired, the contact spool press 795 can push down on the contact spool 794 with an increased force. In some embodiments, the horizontal distance between the contact spool 794 and the tucking arm 796 can be adjustable. The horizontal distance between the contact spool 794 and the tucking arm 796 can be adjusted based on how much contact area between the absorptive material 792 and the electrode material EM is desired. As shown, the densification station 790 is included in the cathode casting station. In some embodiments, the anode casting station can include a densification station. In some embodiments, both the anode casting station and the cathode casting station can include densification stations.

As shown, the densification station 790 is implemented on a flat surface. In some embodiments, the densification station 790 can be implemented on a rotating drum (e.g., the rotating drum 441, as described above with reference to FIGS. 12A-12E). As noted above, rotating drums can be constructed broadly and robustly such that they can withstand forces imposed from densifying. In some embodiments, the film and/or the current collector material CCM can be tucked between the pallets 797 during the densifying. In some embodiments, the densifying can be performed on the same rotating drum as the casting. In other words, the densifying can be performed on the electrode material EM immediately after the electrode material EM is cast.

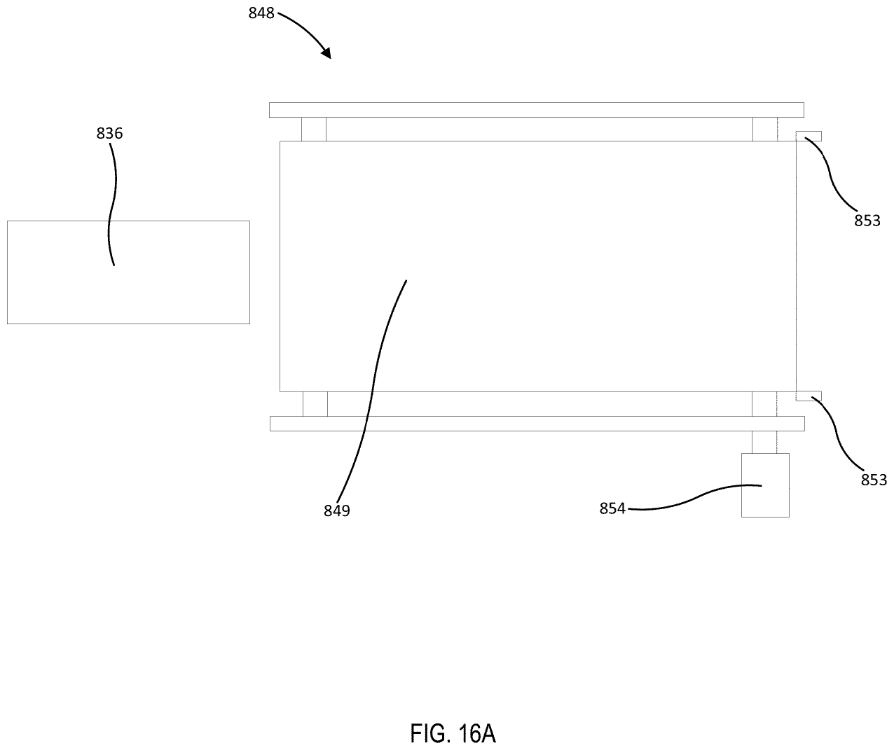

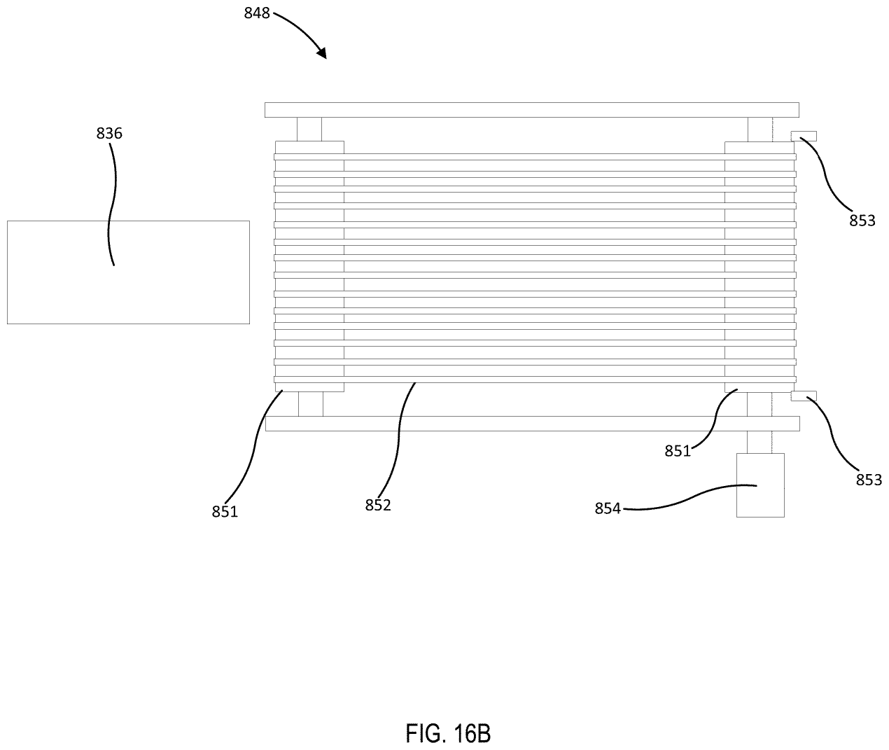

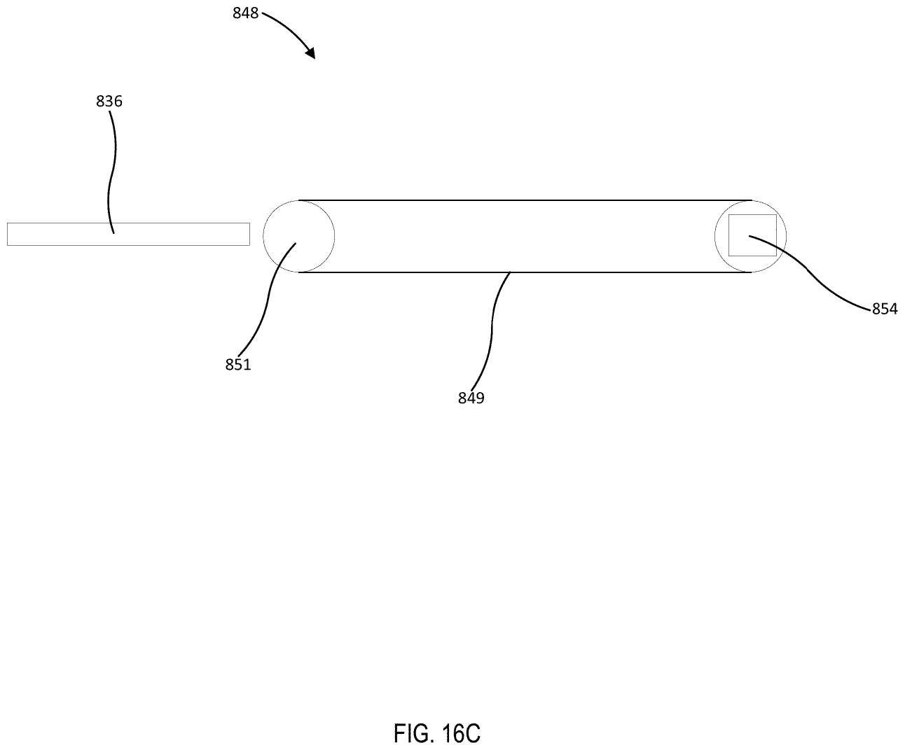

FIGS. 16A-16C are illustrations of a conveyor 848 with a web-steering system incorporated therein, according to an embodiment. FIG. 16A shows a top view of the conveyor 848 with a belt or web 849 visible. FIG. 16B shows a top view of the conveyor belt 848 with the belt 849 removed to show greater detail of additional components. FIG. 16C shows a side view of the conveyor 848. As shown, a nozzle 836 dispenses semi-solid electrode material onto a current collector moving along the belt 849. The conveyor 848 further includes rollers 851, O-rings 852, sensors 853, and an adjuster 854. The semi-solid electrode material is then transported to a cell assembly point where an electrochemical cell is assembled. Assembly of the electrochemical cell has a small margin of error, so proper alignment and precise adjustments of the semi-solid electrode material is important. Positioning of the semi-solid electrode material as it exits the belt 849 (e.g., on the right side of the belt 849, as depicted in FIGS. 16A-16C) is important for alignment of the semi-solid electrode material upon assembling the electrochemical cell.

The rollers 851 rotate while the belt 849 is disposed around the rollers 851 in order to rotate the belt 849. The O-rings 852 are disposed around the rollers 851 and to increase friction and aid in preventing the belt 849 from slipping side-to-side while being rolled around the rollers 851. In some embodiments, the rollers 851 can be disposed in grooves around the rollers 851. Sensors 853 can be disposed near the belt 849 in order to monitor the position and the side-to-side movements of the belt 849.

In some embodiments, the sensors 853 can monitor the position of the edges of the belt 849. In some embodiments, the sensors 853 can be positioned to monitor the location of the edges of the semi-solid electrode. As shown, the conveyor 848 includes two sensors 853. In some embodiments, the conveyor 848 can include 1, 2, 3, 4, 5, 6, 7, 8, 9, 10, or at least about 10 sensors 853, inclusive of all values and ranges therebetween. In some embodiments, the sensors 853 can include photovoltaic cells, photodiodes, photo-resistors, photo-transistors, or any combination thereof.

The adjuster 854 is configured to adjust one or more of the rollers 851 in order to ensure accurate alignment of the belt 849. In some embodiments, the belt 849 can rotate around the rollers 851 at a rate of at least about 100 rpm, at least about 150 rpm, at least about 200 rpm, at least about 250 rpm, at least about 300 rpm, at least about 350 rpm, at least about 400 rpm, at least about 450 rpm, at least about 500 rpm, at least about 550 rpm, at least about 600 rpm, at least about 650 rpm, at least about 700 rpm, at least about 750 rpm, at least about 800 rpm, at least about 850 rpm, at least about 900 rpm, or at least about 1,000 rpm. With the high rotation speed of the belt, the adjuster 854 makes quick adjustments to ensure proper alignment. In some embodiments, the adjuster 854 can make micron-scale adjustments in a short period of time. In some embodiments, the adjuster 854 can make an adjustment over a period of less than about 100 ms, less than about 90 ms, less than about 80 ms, less than about 70 ms, less than about 60 ms, less than about 50 ms, less than about 40 ms, less than about 30 ms, less than about 20 ms, or less than about 10 ms. In some embodiments, the adjuster 854 can adjust the alignment of the belt 849 by about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm, inclusive of all values and ranges therebetween.

In some embodiments, the adjuster 854 can include a servomechanism. In some embodiments, the adjuster 854 can include a servomotor. In some embodiments, the adjuster 854 can include a positional rotation motor, a continuous rotation motor, or a linear motor. As shown, the conveyor 848 includes one adjuster 854 positioned at a side of the conveyor 848 where the semi-solid electrode material exits the conveyor 848. In some embodiments, the conveyor 848 can include multiple adjusters 854 to adjust the position of the belt 848 at multiple locations. Multiple adjusters 854 can potentially cause a more gradual adjustment of the belt 848.

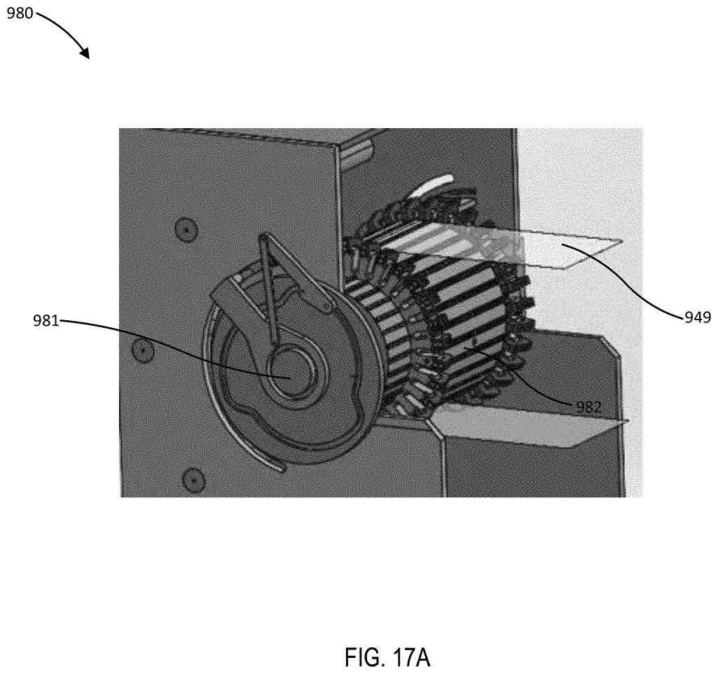

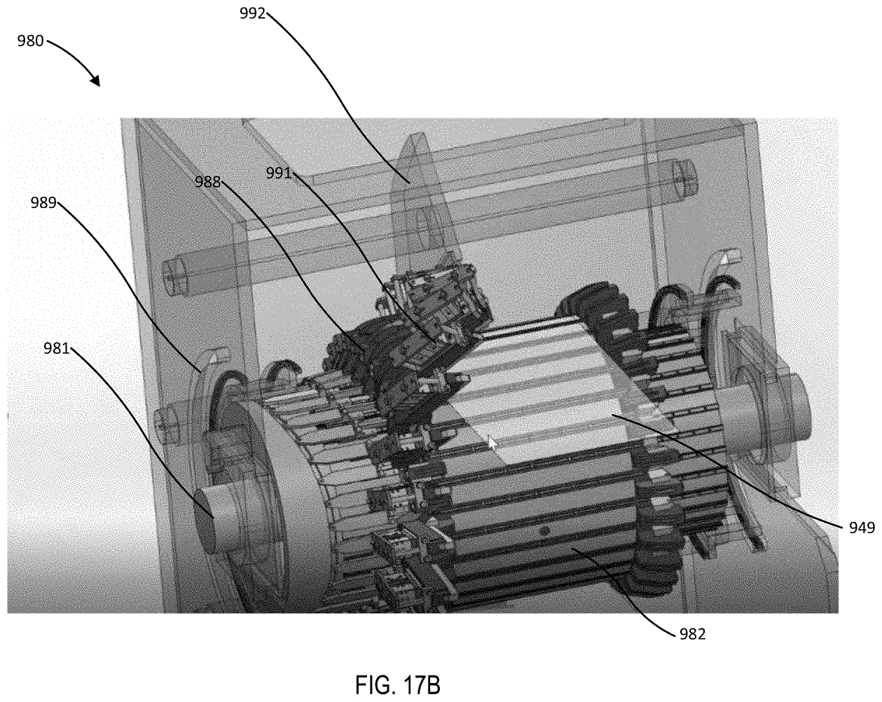

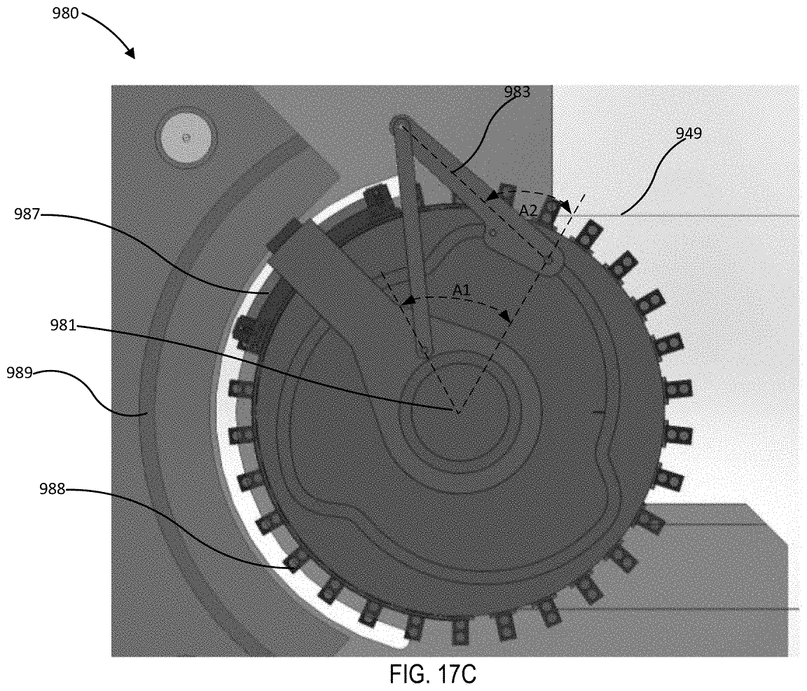

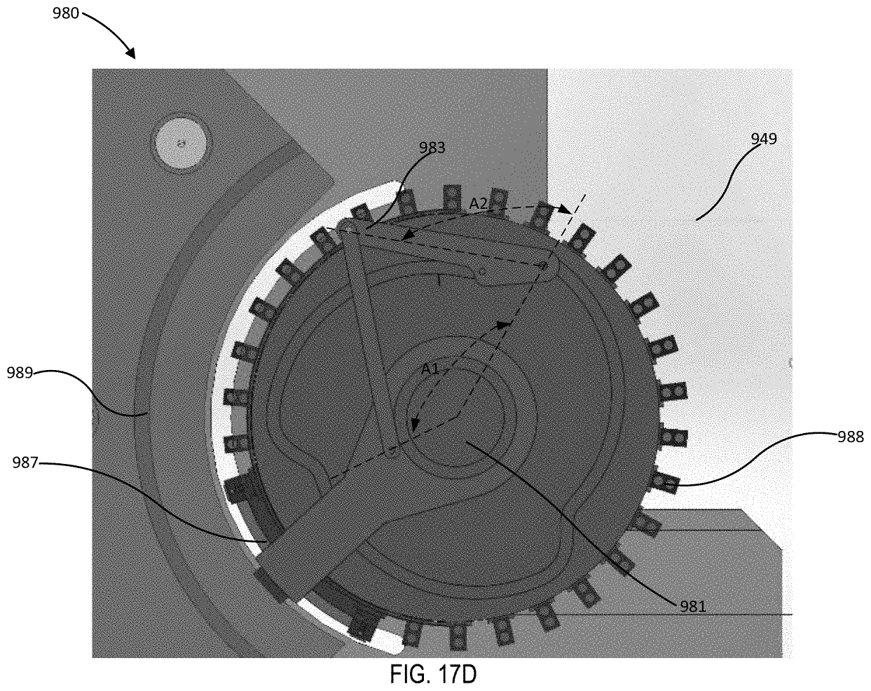

FIGS. 17A-17D are illustrations of a pouch sealer 980, according to an embodiment. As shown, the pouch sealer 980 is an automated heat-sealing pouch sealing apparatus. FIG. 17A shows an auxiliary view of the pouch sealer 980, while FIG. 17B shows an auxiliary view of the pouch sealer 980 with additional machinery visible, FIG. 17C shows a side view of the pouch sealer 980 in a first configuration, and FIG. 17D shows a side view of the pouch sealer 980 in a second configuration. As shown, a belt or web 949 is being fed into the pouch sealer 980. The pouch sealer 980 operates continuously. As shown, the pouch sealer 980 includes a rotating drum 981 with pallets 982 thereon. An arm 983 is connected to the rotating drum 981 and a sealing device 987. The sealing device 987 makes contact with pallet connectors 988 and air cylinders 991 to seal pouches. The sealing device 987 moves along a tracking path 989.

The arm 983 regulates movement of the sealing device 987. As shown, the arm 983 has two segments, and several characteristic angles. The first segment of the arm 983 extends from an edge of the rotating drum 981 outward, where it connects with the second segment of the arm 983. The second segment of the arm 983 is coupled to a point near the center of the rotating drum 981 (e.g., about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm from the center of the rotating drum 981, inclusive of all values and ranges therebetween). The first imaginary line extends from the center of the rotating drum 981 to the coupling point between the first segment of the arm 983 and the rotating drum 981. The second imaginary line extends from the center of the rotating drum to the coupling point between the second segment of the arm 983 and the rotating drum.

Angle A1 refers to an angle between the first imaginary line and the second imaginary line. As the sealing device 987 moves from a top position to a bottom position, angle A1 increases, as the arm 983 becomes fully extended. In some embodiments, when the arm 983 is in the top position, the angle A1 can be about 30°, about 35°, about 40°, about 45°, about 50°, about 55°, about 60°, about 65°, about 70°, about 75°, or about 80°, inclusive of all values and ranges therebetween. In some embodiments, when the arm 983 is in the bottom position, the angle A1 can be about 100°, about 105°, about 110°, about 115°, about 120°, about 125°, about 130°, about 135°, about 140°, about 145°, about 150°, about 155°, about 160°, about 165°, or about 170°, inclusive of all values and ranges therebetween.

Angle A2 refers to an angle between the first imaginary line and the first segment of the arm 983. As the sealing device 987 moves from the top position to the bottom position, angle A2 increases, as the arm 983 becomes fully extended. In some embodiments, when the arm 983 is in the top position, the angle A2 can be about 50°, about 55°, about 60°, about 65°, about 70°, about 75°, about 80°, or about 85°, inclusive of all values and ranges therebetween. In some embodiments, when the arm 983 is in the bottom position, the angle A2 can be about 95°, about 100°, about 105°, about 110°, about 115°, about 120°, about 125°, or about 130°, inclusive of all values and ranges therebetween.

The sealing device 987 controls administration of air to the air cylinders 981 to apply pressure to the web 949 and the pouch material thereon. As the rotating drum 981 rotates, the air cylinders 991 are pushed to contact the web 949 and the pouch material thereon via a guiding plate 992. In some embodiments, the guiding plate 992 can be configured to move axially along the length of the rotating drum 981. The air cylinders 991 contact the web 949 while the sealing device 987 is in a sealing position. In some embodiments, the sealing position can be the top position of the sealing device 987. In some embodiments, the sealing position can be the bottom position of the sealing device 987. When the sealing device 987 is in the sealing position and the air cylinders 991 contact the web 949, heat seal bands (not shown) inside the rotating drum 981 and below the web 949 are energized. In some embodiments, power to the air cylinders 991 can be supplied via the sealing device 987. Air pressure is provided to the air cylinders 991 via the sealing device 987 and apply pressure to the web 949 and the pouch material disposed thereon to ensure a uniform pressure and induce heat transfer.

As the rotating drum 981 rotates, the sealing device 987 is fluidically and/or electronically coupled to n air cylinders at a time 991, wherein n is a positive integer. As shown, n is 5. In some embodiments, n can be 1, 2, 3, 4, 5, 6, 7, 8, 9, 10, 11, 12, 13, 14, 15, 16, 17, 18, 19, 20, or at least about 20. After the sealing device 987 has executed the pressurization and sealing, the sealing device 987 moves from the top position of the tracking path 989 to the bottom position of the tracking path 989 (or vice versa) via cams in the rotating drum 981. In switching positions on the tracking path 989, the sealing device can pass over or skip several pallet connectors 988 and air cylinders 991 (e.g., n pallet connectors 988 and n air cylinders 991). In some embodiments, a second sealing device (not shown) can be disposed on the opposite side of the rotating drum 981. The second sealing device can operate in a staggered arrangement from the first sealing device 987. For example, the first sealing device 987 can seal cells 1-5, while the second sealing device can seal cells 6-10, the first sealing device 987 can seal cells 11-15, the second sealing device can seal cells 16-20, and so on.

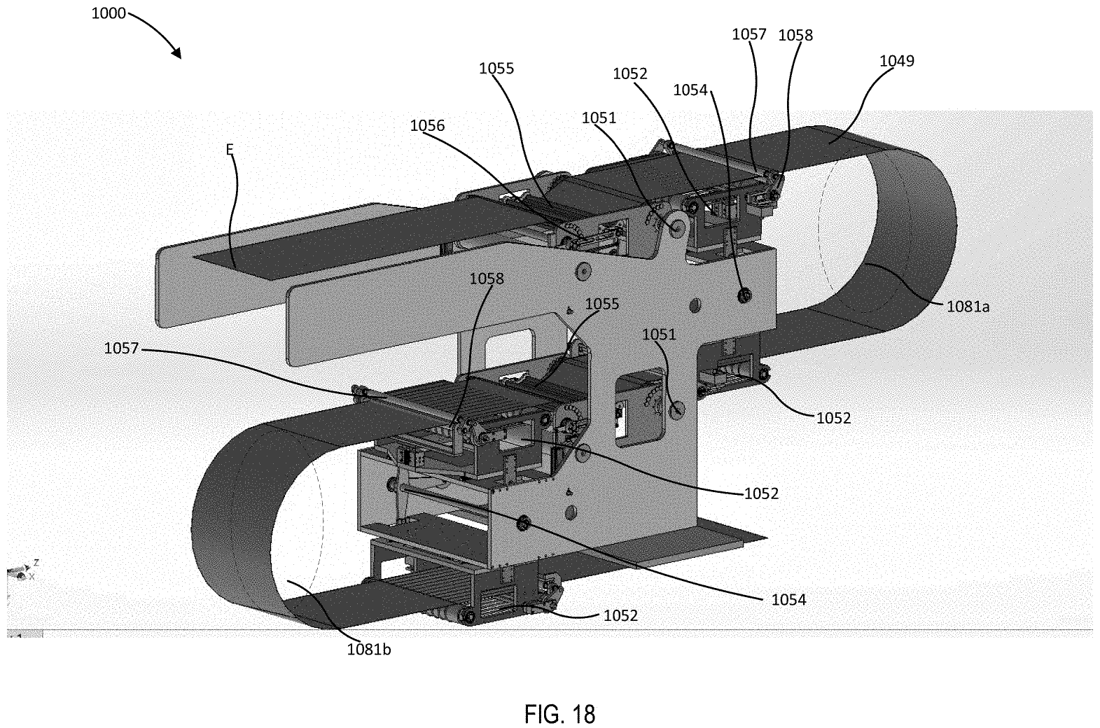

FIG. 18 is an illustration of a web steering apparatus 1000, according to an embodiment. As shown, the web steering apparatus 1000 includes a web 1049, rollers 1051, O-ring belts 1052, idlers 1054, dancers 1055, dancer arms 1056, pressure rollers 1057, and lifting rollers 1058. Rotating drums 1081a, 1081b (collectively referred to as rotating drums 1081) can be placed on either side of the web steering apparatus 1000. In some embodiments, the steering apparatus 1000 can be employed in a space where the web 1049 does not steer onto a drum. In some embodiments, the rotating drums 1081 can include any of the properties or components of the rotating drum 981 (e.g., an arm), as described above with reference to FIGS. 17A-17D. The web steering apparatus 1000 is configured to facilitate alignment of electrodes and create constant tension in the web 1049. The web steering apparatus 1000 also includes tension control zones created throughout the web steering apparatus 1000.

In use, an anode, cathode, and separator, can be joined and heat tacked and enter the web steering apparatus 1000 at an entry point E via the web 1049. The anode, cathode, and separator can be contained inside the web 1049 as the web 1049 is advanced along the web steering apparatus 1000. The web 1049 passes over the rollers 1051 and under the dancers 1055 to create an arc path. The dancers 1055 can be controlled to move upward and downward by the dancer arms 1056. The movement of the dancers 1055 can shape the movement path of the web 1049. In some embodiments, one or more of the dancer arms 1056 can be controlled via a low friction gas spring (not shown), which applies a force to the dancer arm 1056, such that the dancer arm 1056 moves the dancer 1055 upward or downward. The web 1049 then passes along the O-ring belts 1052, where the web 1049 is aligned prior to entering the rotating drum 1081a. The edges of the electrochemical cells in the web 1049 are heat-sealed in the rotating drum 1081a. The web 1049 advances again through an additional set of rollers 1051, dancers 1055, and O-ring belts 1052 before entering the rotating drum 1081b. A second seal can be formed along the equator of each electrochemical cell in the rotating drum 1081b.

As shown, the rollers 1051 are each oriented in an arc. The arc orientation of the rollers 1051 creates a large radius of curvature, around which the web 1049 advances. A larger radius of curvature is less likely to cause damage to electrodes or cells traveling via the web 1049 than a smaller radius of curvature, because the electrodes or cells can bend more when traveling about a smaller curvature radius. In some embodiments, a large roller can be used instead of a series of small rollers formed in an arc.

The O-ring belts 1052 include one or more O-rings that rotate and move the web 1049 by frictionally engaging the web 1049 (i.e., applying a normal force to the web 1049). In some embodiments, the pressure rollers 1058 can push down on the web 1049 to frictionally engage the web 1049 with the O-rings. In use, the web 1049 can sometimes roll out of its proper alignment. The idlers 1054 can momentarily separate the web 1049 from the O-ring belt 1052 (e.g., by moving the O-ring belt 1052 relative to the web 1049 or by moving the web 1049 relative to the O-ring), such that the O-ring belt 1052 can re-home to a central position without dragging the web 1049 along with it. The lifting rollers 1058 can lift the web 1049 to allow the O-ring belts 1052 to re-home their alignment. The O-ring belts 1052 steer the web 1049 onto the rotating drums 1081 for heat sealing. When mounted as shown on linear bearings with a lever system therebetween, this allows the O-ring belts 1052 to advance or retard the web 1049 entering the drums 1081. This can be accomplished in multiple ways. In some embodiments, each O-ring belt 1052 can be servo controlled for rpm control. In some embodiments, each 0-ring belt 1052 can be automatically positioned to advance or retard the web 1049 relative to the phase angle of the drum 1081.

As shown, the web 1049 is advanced about the rotating drums 1081. In some embodiments, the rotating drums 1081a, 1081b can have differing angular velocities. In such a case, the dancer arms 1056 can control tension in the web 1049 by applying a force. The pressure in the gas springs that propel the dancer arms 1056 can be regulated via a machine control system automatically. Additionally, the dancers 1055 can afford the web alignment system 1000 to advance and retard on demand or in real time. The web alignment system 1000 can either advance or retard the web 1049 on the rotating drums 1081 to align the heat sealer (not shown) of the rotating drums 1081 to the space between the electrochemical cells in the web 1049. The dancers 1055 can either supply a length of the web 1049 or take up portions of the web 1049 while maintaining a constant tension. In some embodiments, if the web 1049 is moving at a high speed, the dancers 1055 can accelerate faster than the acceleration of gravity, and gas springs can facilitate this motion.

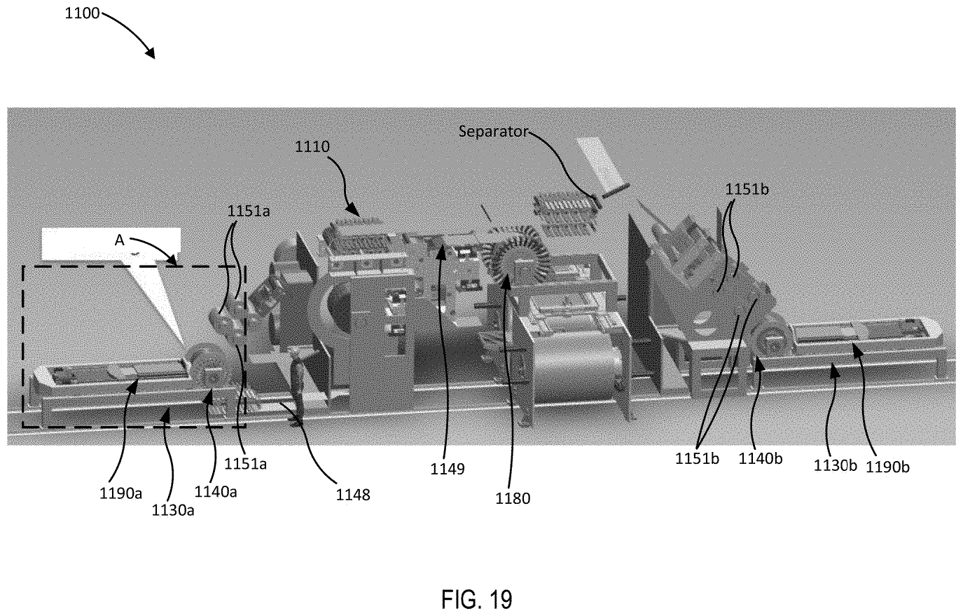

FIG. 19 is an illustration showing a system 1100 for semi-continuous or continuous manufacture of a semi-solid electrode, according to an embodiment. As shown, the system 1100 includes a cathode casting station 1130a including a cathode casting drum 1140a and a cathode casting assembly 1190a, an anode casting station 1130b including an anode casting drum 1140b and an anode casting assembly 1190b, one or more belts or conveyor 1148 that may be substantially similar to the conveyor 148 as previously described, and that may serve to transport a cathode or anode current collector material, or a web 1149 (e.g., a first web 1149a and a second web 1149b, collectively referred to as webs 1149). The system 1100 may also include one or more rollers 1151, a pouch sealer 1180, and a web alignment assembly 1110. Moreover, the system 1100 can optionally, also include a compressor (e.g., the compressor 120), a cartridge (e.g., the cartridge 130), and a shaping device (e.g., the shaping device 150). In some embodiments, the system 1100 can also include a gravity dryer (e.g., the gravity dryer 110), a mixer (e.g., the mixer 118), a laser cutting device (e.g., the laser cutting device 140), a wetting device (e.g., 160, a tunnel 168, an adjoining system 170, and a pouch sealer 180. In some embodiments, the system 100 can be used for implementing the method 10, as described above with reference to FIG. 1.

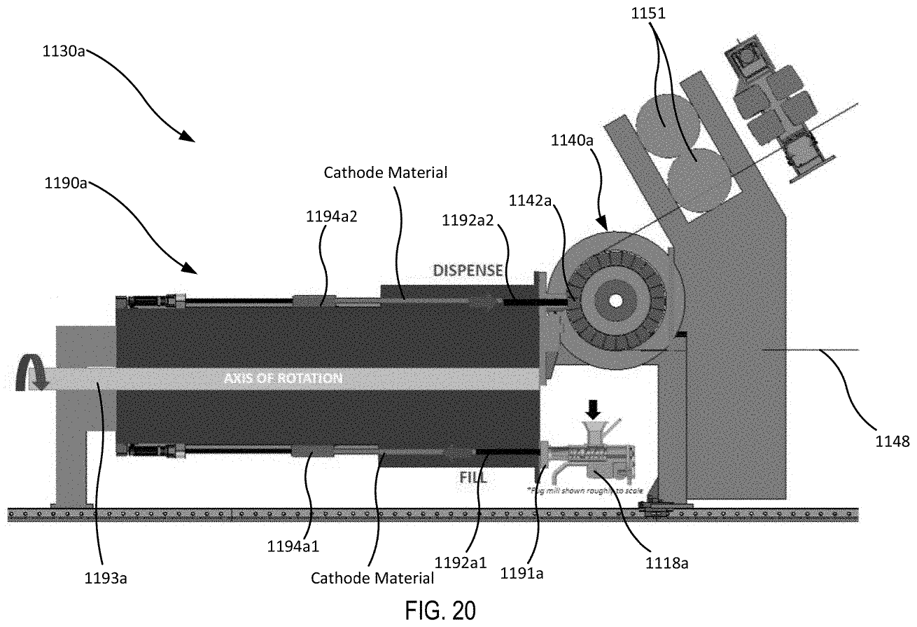

FIG. 20 shows a side cross-section view of a portion of the system 1100 indicated by the arrow A in FIG. 19, which includes the cathode casting station 1130a. The cathode casting station 1130a is configured to receive a cathode current collector material, for example, a foil or strip of metal and configured to cast the semisolid cathode material on predetermined portions of the cathode current collector material that is being conveyed in a continuous, near continuous, or semi-continuous fashion via the conveyor 1148. The conveyor 1148 moves semi-solid electrodes through the additional process units of the system 1100. In some embodiments, the system can include multiple conveyors (not shown). In some embodiments, multiple conveyors can be used to put multiple electrodes together, as described in the '025 publication. The anode casting station 1130b is substantially similar to the cathode casting station 1130a with the difference that the anode casting station 1130b is configured to receive an anode current collector material, for example, a foil or strip of metal and configured to cast the semisolid anode material on predetermined portions of the anode current collector material that is being conveyed in a continuous, near continuous, or semi-continuous fashion via the conveyor 1148. Thus, while only the cathode casting station 1130a is described in detail with respect to FIG. 20, it should be appreciated that the anode casting station 1130b is substantially similar in structure and function to the cathode casting station 1130a.

As shown in FIG. 20, the cathode casting drum 1140 includes a plurality of pallets 1142a that may selectively radially displace proximate to or radially distal from each other as the drum 1140a rotates. A first portion of the cathode current collector material is disposed on each of the pallets 1142a such that a second portion of the cathode current collector material is crimped between adjacent pallets as they rotate. In some embodiments, the cathode casting drum 1140a may be substantially similar in structure and function to the rotating drum 441, as previously described, and therefore, not described in further detail herein.

The cathode casting station 1130a may include a mixer 1118 configured to mix active material, conductive material, and electrolyte to form a semi-solid electrode material. In some embodiments, the mixer 1118 can include a pug mill. In some embodiments, the mixer 1118 can include a single-screw extruder. In some embodiments, the mixer 1118 can include a twin-screw extruder. In some embodiments, the mixer 1118 can include a twin-screw kneader. In some embodiments, the mixer can include any of the mixers mentioned in the '569 patent. In some embodiments, the mixer 1118 can be fluidically coupled to a gravity dryer (e.g., the gravity dryer) 110 such that material can flow continuously from the gravity dryer 110 to the mixer 1118. In some embodiments, the mixer 1118 may also include a compressor (e.g., the compressor 120), for example, to compress the semisolid cathode material into an electrode brick. In some embodiments, the mixer 1118 may be configured to receive semisolid electrode material or slurry pieces or chunks via a conveyor or a hopper.

The cathode casting assembly 1190a may include casting turret 1191a that may be mounted on an axle 1193a along its central axis. The axle 1193a may be operatively coupled to actuator (e.g., a motor) that is configured to rotate the casting turret 1191a in a clockwise and/or anticlockwise direction by an angle of at least 180 degrees. The casting turret 1191a defines at least a first chamber 1192a1 and a second chamber 1192a2, each of which is configured to selectively receive a predetermined volume of the semisolid cathode material from the mixer 1118, and selectively dispense the predetermined volume of the semisolid cathode material on a corresponding pallet 1142a of the casting drum 1140a. Each of the first chamber 1192a1 and the second chamber 1192a2 may be disposed axially parallel to and radially offset from the axle 1192a. A first dispensing mechanism 1194a1 and a second dispensing mechanism 1194a2 are operatively coupled to the first chamber 1192a1 and the second chamber 1192a2, respectively, and configured to selectively dispense the semisolid cathode material disposed therein onto a corresponding pallet 1142a of the casting drum 1140a. Any dispensing mechanism may be used such as, for example, a piston, a compressor configured to communicate compressed gas (e.g., air, nitrogen, etc.) through the first chamber 1192a1 or the second chamber 1192a2 to force the semisolid cathode material contained therewithin out of the first chamber 1192a1 or the second chamber 1192a2 and onto the corresponding pallet 1142a, i.e., onto the portion of the cathode current collector that is disposed on the corresponding pellet at that particular time.

Expanding further, in some embodiments, the first chamber 1192a1 may be radially offset from the second chamber 1192a2 by an angle of about 180 degrees. In a first configuration as shown in FIG. 20, the first chamber 1192a1 may be axially aligned with an outlet of the mixer 1118a so as to be in fluidic communication with an outlet of the mixer. In some embodiments, a sealing member 1119a may be disposed at or around the outlet of the mixer 1118a to form a seal with an inlet of a corresponding one of the first chamber 1192a1 or the second chamber 1192a2 that is axially aligned with the outlet of the mixer 1118a depending on whether assembly 1190a is in the first configuration or a second configuration.

In the first configuration, the first chamber 1192a1 receives the predetermined volume of the semisolid cathode material from the mixer 1118a. In some embodiments, a rotation speed can cause the casting turret 1191a to have a dwell time while being axially aligned with the outlet of the mixer 1118a. In some embodiments, the dwell time may be selected so as to cause the predetermined volume of the semisolid cathode material to be received in the first chamber 1192a1 from the mixer 1118a. In the first configuration, the second chamber 1192a2 is axially aligned with a corresponding pallet 1142a of the casting drum 1140a. While the first chamber 1192a1 is being filled with the semisolid cathode material, the second dispensing mechanism 1194a2 is selectively actuated to dispense the semisolid cathode material disposed therein onto the corresponding pallet 1142a, for example a first pallet.

In the second configuration, the casting turret 1191a is rotated about the axle 1193a such that the first chamber 1192a1 is now aligned with a corresponding pallet 1142a, for example, a second pallet that is radially adjacent to the first pallet, and the second chamber 1192a2 is axially aligned with the outlet of the mixer 1118a. Thus, in the second configuration, the second chamber 1192a2 is filled with the predetermined volume of the semisolid cathode material and the semisolid cathode material already disposed in the first chamber 1192a1 is dispensed via the first dispensing mechanism 1194a1 onto a portion of the cathode current collector material disposed on a corresponding pallet 1142a that is axially aligned with the first chamber 1192a1 at that time. For example, once the first chamber 1192a1 is filled with the semisolid cathode material, the semisolid cathode material loading is stopped, the first chamber 1192a1 is gated (e.g., closed via a portion of the casting assembly 1190a or a movable gate), and pressure may be built up in the first chamber 1192a1 such that when the first chamber 1192a1 is rotated by about 180 degrees (e.g., from about a 6 o'clock to a 12 o'clock position) such that dispensing can begin immediately once the first chamber 1192a1 is about axially aligned with the corresponding pallet 1142a.

In some embodiments, the rotation of the casting turret 1191a about the axle 1193a between filling the first chamber 1192a1 and dispensing the semi-solid electrode material from the first chamber 1192a can be about 80 degrees, about 90 degrees, about 100 degrees, about 110 degrees, about 120 degrees, about 130 degrees, about 140 degrees, about 150 degrees, about 160 degrees, about 170 degrees, about 180 degrees, about 190 degrees, about 200 degrees, about 210 degrees, about 220 degrees, about 230 degrees, about 240 degrees, about 250 degrees, about 260 degrees, about 270 degrees, or about 280 degrees, inclusive of all values and ranges therebetween.

The rotation of the casting drum 1140a and the casting turret 1191a, as well as the dispensing speed of the mixer 1118a may be synced such that in the time period that first chamber 1192a1 is filled with the semisolid cathode material and experiences a 180 degree rotation, the first pallet of the pallets 1142a on which semisolid cathode material from the second pallet 1142a was dispensed has rotated away and the adjacent second pallet of the pallets 1142a is axially aligned with the first chamber 1192a1, thereby allowing dispensing of the semisolid cathode material onto the cathode current collector material disposed on the second pallet. In this manner, continuous, near continuous, or semi-continuous dispensing of the semisolid cathode material can be performed on the cathode current collector material. In some embodiments, a filling and rotation time of the casting turret 1191a may be in a range of about 5 seconds to about 30 seconds, inclusive.

In some embodiments, the casting turret 1190a may be configured to allow conducting of quality control checks on the semisolid electrode material filled in each of the first chamber 1192a1 and/or the second chamber 1192a2 during operation, for example, via a load piston or any other suitable sensor that can sense various parameters of the loaded semisolid cathode material (e.g., through a wall of the casting turret 1191a). If a loaded semisolid cathode slurry fails quality control, the casting turret 1191a may be configured to be moved into a third configuration between the first and the second configurations, for example, in which the first chamber 1192a1 is in the 9 o'clock position and the second chamber 1192a2 is in the 3 o'clock position. The rejected semisolid cathode material may be expelled out of the corresponding first chamber 1192a1 or second chamber 1192a2, for example, in waste or recycling receptacle, and subsequently, the first chamber 1192a1 or the second chamber 1192a2 may be brought into the alignment with the mixer 1118a via rotation of the casting turret 1191a.

While FIG. 20 shows the casting turret 1191a as defining only the first chamber 1192a1 and the second chamber 1192a2, in other embodiments, the casting turret 1191a may define a plurality of chambers, for example, 3, 4, 5, 6, or even more. A larger number of chambers may increase throughput by allowing faster rotation of the casting drum 1140a without having to significantly increase rotational speed of the casting turret 1191a.

Referring again to FIG. 19, the system 1100 may also include a first plurality of rollers 1151a configured to route the cathode current collector material with the semisolid cathode material thereon towards other assemblies included in the system 100. Similarly, the system 1100 may also include a second plurality of rollers 1151b configured to route the anode current collector material with the semisolid anode material thereon towards other assemblies included in the system 1100.

In some embodiments, each of the cathode and anode casting stations 1130a/b can include optical measurement devices as well as x-rays. The optical measurement devices and x-rays can be used for quality control to confirm the thickness of the semi-solid electrodes after being formed. In some embodiments, the anode can be formed at the anode casting station 1130b with the anode material disposed on a current collector and/or a pouch material. In some embodiments, the cathode can be formed at the cathode casting station 1130a with the cathode material disposed on a current collector and/or a pouch material.

In some embodiments, after being formed at the cathode casting station 1130a, the cathode material can be passed through a spray enclosure. In some embodiments, a wetting device (e.g., the wetting device 160) and/or a tunnel (e.g., the tunnel 168) can be inside the spray enclosure. In some embodiments, solvents can be sprayed on the anode material and/or the cathode material in the spray enclosure. In some embodiments, the solvents sprayed on the cathode material can be flammable. The use of a spray enclosure can aid in preventing ignition by keeping concentration levels of flammable materials outside of an ignitable range. In some embodiments, the spray enclosure includes an exhaust to vent the spray enclosure to the surrounding environment and keep the concentration of flammable materials below a flammable limit. In some embodiments, the spray enclosure can be explosion proof. In some embodiments, the cathode material can pass through a spray enclosure. In some embodiments, the anode material can pass through a spray enclosure. In some embodiments, the anode material can pass through a first spray enclosure and the cathode material can pass through a second spray enclosure. In some embodiments, the anode material and the cathode material can pass through the same spray enclosure.

In some embodiments, the spray enclosure can be purged of oxygen to reduce the risk of ignition inside the enclosure. In some embodiments, the purging of oxygen can be via vacuuming the spray enclosure. In some embodiments, the purging of oxygen can be via influx of inert gas (e.g., nitrogen, argon) into the spray enclosure. In some embodiments, the purging of oxygen can be via vacuuming the spray enclosure and influx of inert gas into the spray enclosure.

In some embodiments, the formed anode material, the formed cathode material, and a separator material can all be fed to a vacuum drum (not shown), where the anode material, the cathode material, and the separator are merged together. In some embodiments, each of the anode material, the cathode material, and the separator can wrap around the vacuum drum at different points along the vacuum drum to form the layers of the electrochemical cell. In some embodiments, the vacuum drum can apply a force to the electrodes to increase their densities, as described in detail with respect to the system 100. As shown, the separator material is fed adjacent to the anode casting station 1130b. In some embodiments, the separator material can be fed adjacent to the cathode casting station 1130a. In other words, the positioning of the anode casting station 1130b and the cathode casting station 1130a can be switched from how they are depicted in FIG. 19.

In some embodiments, the vacuum drum can have a diameter of at least about 1 cm, at least about 5 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the vacuum drum can have a diameter of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, or no more than about 5 cm. Combinations of the above-referenced diameters of the vacuum drum are also possible (e.g., at least about 1 cm and no more than about 1 m or at least about 10 cm and no more than about 50 cm), inclusive of all values and ranges therebetween. In some embodiments, the vacuum drum can have a diameter of about 1 cm, about 5 cm, about 10 cm, about 20 cm, about 30 cm, about 40 cm, about 50 cm, about 60 cm, about 70 cm, about 80 cm, about 90 cm, or about 1 m.

In some embodiments, the vacuum drum can be held in place with a tack. In some embodiments, the vacuum drum can include multiple members disposed around a perimeter of the vacuum drum. In some embodiments, the members can include pallets. In some embodiments, the vacuum drum can include a central duct with a vacuum for removal of liquids from the material on the outside of the vacuum drum. After merging together, a laser cutter can cut the anode material, the cathode material, and the separator to form individual electrochemical cells. As shown, the individual electrochemical cells can be conveyed across a vacuum conveyor. In some embodiments, the vacuum conveyor can remove stray particles from the electrochemical cells. The individual electrochemical cells can be measured via optical measurement for quality control. The individual electrochemical cells can then selectively slide off of the vacuum conveyor, depending on whether they pass the quality control test.

In some embodiments, the system 1100 can include a first vacuum drum that receives a feed of cathode material and separator material and a second vacuum drum that receives a feed of anode material. In some embodiments, the first vacuum drum presses the separator material and the cathode material to a conveyor, and then the second vacuum drum presses the anode material onto the cathode material and the separator.

In some embodiments, the anode casting station and/or the cathode casting station can include a densification station (not shown). In some embodiments, the densification station can employ any of the electrode densification methods described in the '192 publication.

In some embodiments, the system 100 can produce at least about 100, at least about 150, at least about 200, at least about 250, at least about 300, at least about 350, at least about 400, at least about 450, at least about 500, at least about 550, at least about 600, at least about 650, at least about 700, at least about 750, at least about 800, at least about 850, at least about 900, at least about 950, or at least about 1,000 electrodes per minute, inclusive of all values and ranges therebetween. In some embodiments, the system 100 can produce at least about 100, at least about 150, at least about 200, at least about 250, at least about 300, at least about 350, at least about 400, at least about 450, at least about 500, at least about 550, at least about 600, at least about 650, at least about 700, at least about 750, at least about 800, at least about 850, at least about 900, at least about 950, or at least about 1,000 electrochemical cells per minute, inclusive of all values and ranges therebetween.

In some embodiments, the system 1100 includes the pouch sealer 1180 that may be configured to receive the merged electrochemical cell materials disposed between layers of a pouch material, for example, from the web alignment assembly. The pouch sealer 1180 may be configured to seal the pouch around the outside edges of the electrochemical cell. In some embodiments, the pouch sealer 1180 can include an impulse heater. In some embodiments, the pouch sealer 1180 can have a shape, such that it can seal around the outside edge of the electrochemical cell in a single step. In some embodiments, the pouch sealer 1180 is substantially similar in structure and function to the pouch sealer 980 and therefore, not described in further detail herein.

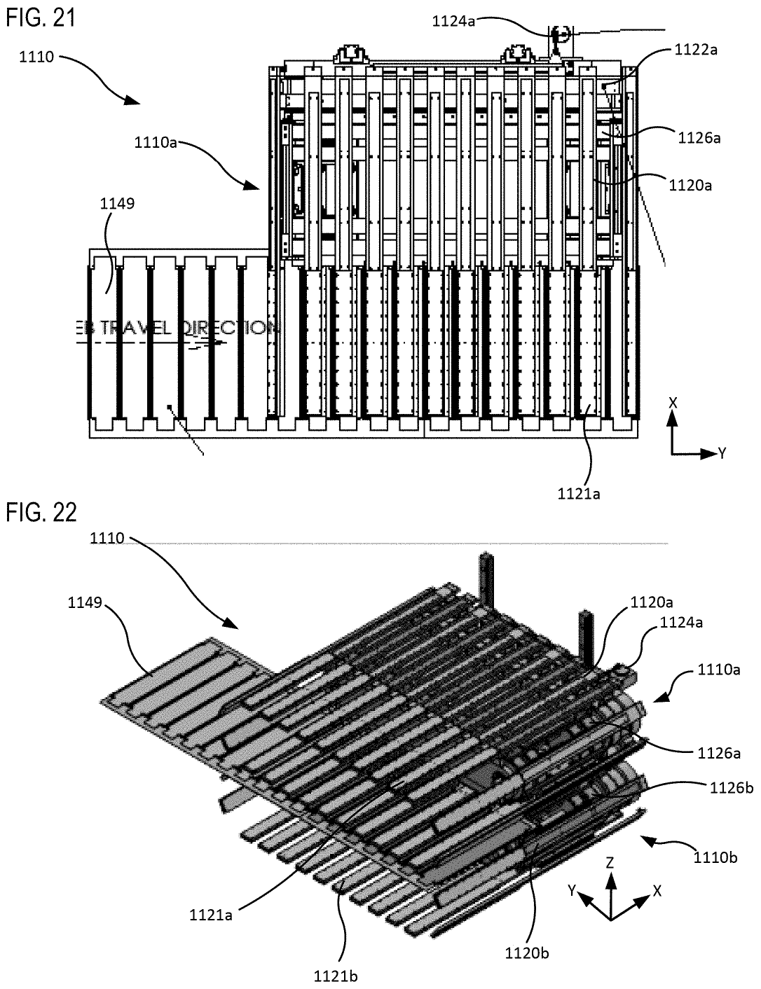

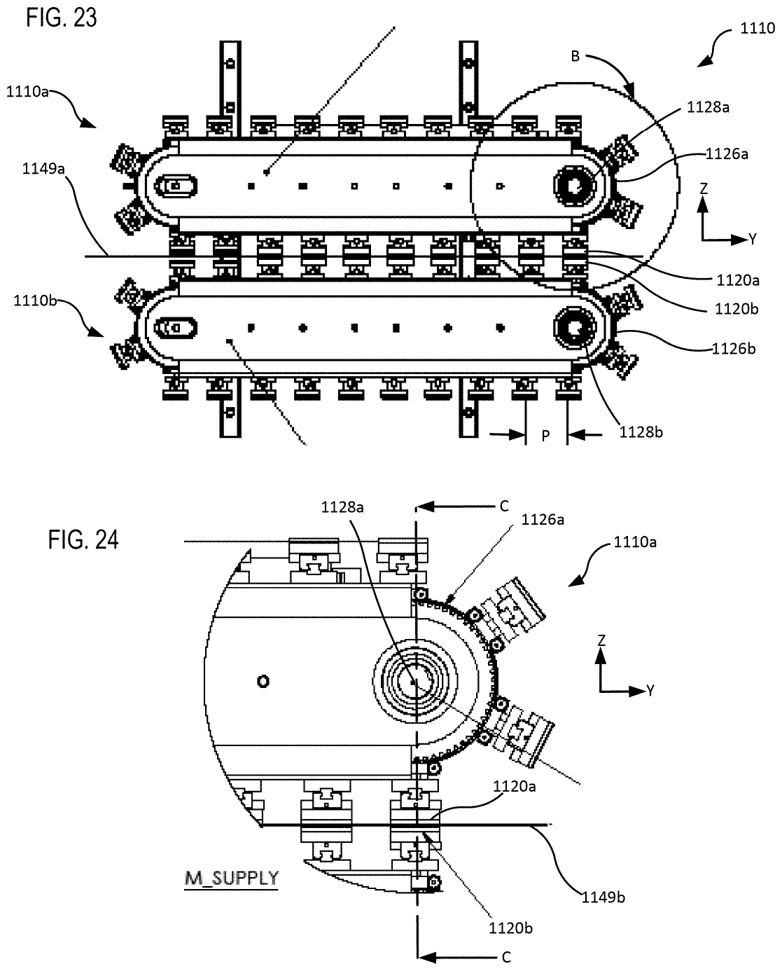

FIGS. 21-25 show various views of a web alignment assembly 1110 (hereinafter “assembly 1110”) that may be included in the system 1100 or any other system described herein (e.g., the system 100). In some embodiments, the web alignment assembly 1100 may be configured for continuous or near continuous motion alignment of a first web with a second web between which the merged components of the electrochemical cell are disposed. In some embodiments, as shown in FIGS. 22 and 23, the assembly 1110 includes a first web alignment subassembly 1110a (hereinafter “first subassembly 1110a”) and a second web alignment subassembly (hereinafter “second subassembly 1110b”) disposed below the first subassembly 1110a in the Z-direction. As shown in FIGS. 21-25, the Y-direction refers to travel direction of the webs 1149, the X-direction refers to a transverse or cross-web direction, and the Z-direction refers to the vertical direction.

The first subassembly 1110a includes a first plurality of vacuum chucks 1120a disposed on or coupled to a first conveyor 1126a, for example, a timing belt, drive, or chain that is mounted on a first motor 1128a (e.g., a servo motor). Moreover, the second subassembly 1110b includes a second plurality of vacuum chucks 1120b disposed on or coupled to a second conveyor 1126b (e.g., a timing belt, drive, or chain) that is mounted on a second motor 1128b (e.g., a servo motor). Each of the vacuum chucks 1120a/b may be spaced apart from an adjacent chuck 1120a/b by a predetermined pitch P, for example, in a range of about 50 mm to about 750 mm, inclusive. The first motor 1128a and the second motors 1128b may be configured to rotate in opposite directions such that the first plurality of vacuum chucks 1120a and the second plurality of vacuum chucks 1120b move in same direction in the Y-direction as shown in FIGS. 22-23.

Each of the first vacuum chucks 1120a have a first engagement portion 1121a, and each of the second vacuum chucks 1120b have a second engagement portion 1121b that extends in the X-direction beyond an axial extent of the motors 1128a and 1128b over the webs 1149 and are configured to engage and align the webs 1149 relative to each other. Moreover, each of the vacuum chucks 1120a/b have three degrees of freedom or are configured to selectively displace in each of the X, Y, and Z-directions. As shown, the first engagement portion 1121a and the second engagement portion 1121b include vacuum holes (not shown) to provide a fluidic pathway for application of the vacuum. This allows a first vacuum chuck 1120a of the first plurality of first vacuum chucks 1120a to move along the direction of web travel (i.e., the Y-direction) along with a corresponding second vacuum chuck 1120b while being proximate to and aligned with the corresponding second vacuum chuck 1120b in the X and Y direction as well as hold the first web 1149a over a corresponding second web 1149b at variable and controllable “ride height” or spacing relative to each other. The vacuum holes can have any form factor, including circular, elliptical, rectangular, square, slot-shaped, star-shaped, or any combination thereof.

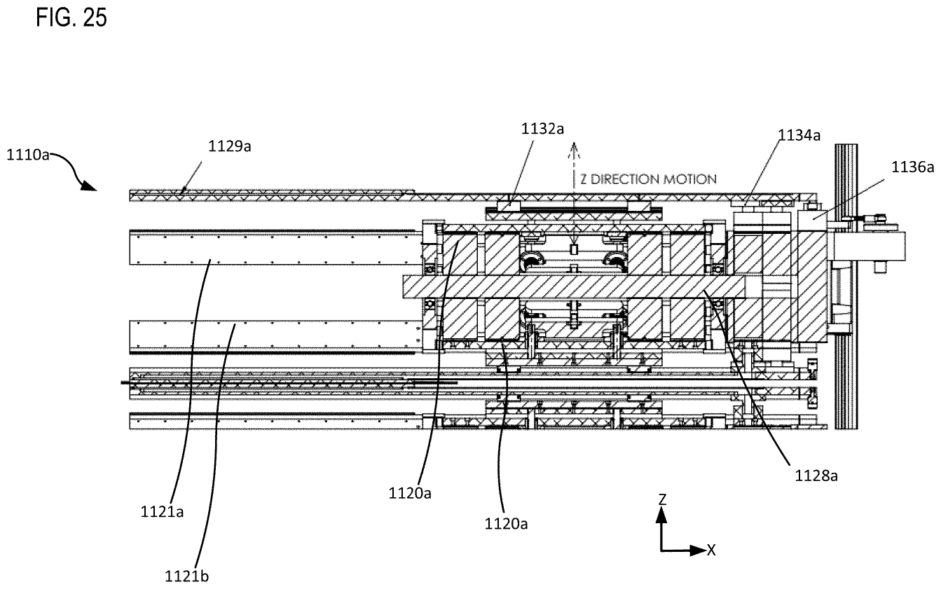

In some embodiments, as shown in FIG. 25, each of the first vacuum chucks 1120a (and similarly, the second vacuum chucks 1120b) may be mounted on one or more first bearings 1132a that allow linear translation of the respective first vacuum chucks 1120a (and similarly, the second vacuum chucks 1120b) in the X-direction, and optionally, may also be mounted on one or more second bearings (not shown) that allow movement of the first vacuum chucks 1120a (and similarly, the second vacuum chucks 1120b) in the Z-direction. A steering mechanism 1136a (e.g., a linear actuator or servo motor) is coupled to the first vacuum chucks 1120a (and similarly, the second vacuum chucks 1120b) and configured to move the first vacuum chucks 1120a in the X-direction. In some embodiments, a servo motor can adjust the position of the vacuum chucks 1120a, 1120b and align the electrochemical cells between the first web 1149a and the second web 1149b while in motion.

In some embodiments, the assembly 1100, for example, the first subassembly 1100a and/or the second subassembly 1100b may include a machine vision system 1124a (e.g., a camera such as charge-coupled device (CCD) camera, an infrared (IR) camera, etc.) or any other sensing system configured to determine a relative spacing of the first web 1149a from the second web 1149b during operation of the assembly 1100 and adjust the relative positions of at least a portion of first plurality of vacuum chucks 1120a and a corresponding portion of the second plurality of vacuum chucks 1120b to align the webs 1149 relative to each other.

In some embodiments, the vacuum chucks 1120a, 1120b can be fastened to a timing belt (e.g., the conveyors 1126a, 1126b, included in the conveyors 1126a, 1126b, or coupled to the conveyors 1126a, 1126b) to provide synchronous motion of the vacuum chucks 1120a, 1120b. In some embodiments, an additional set of timing belts can be connected to the pallets 1142a, 1142b through a vacuum transfer connection. In some embodiments, the vacuum connection can be spring loaded against the back side of the vacuum chucks 1120a, 1120b. In some embodiments, the vacuum connection can be supplied through slots in the vacuum chucks 1120a, 1120b to allow for motion in the X-direction to occur, while maintaining alignment of the vacuum connection. In some embodiments, the vacuum chucks 1120a, 1120b can include bearings to allow for motion in the Z-direction. Motion in the Z-direction can allow for the first web 1149a and the second web 1149b to be brought close together before they are aligned with each other and mated. The motion in the Z-direction can also prevent the chordal action of the vacuum chucks 1120a, 1120b from striking the webs 1149 as they travel around the first conveyor 1126a and the second conveyor 1126b.

In some embodiments, a rotary slide (not shown) can allow the vacuum chucks 1120a, 1120b to be actuated while the vacuum chucks 1120a, 1120b are advancing. In some embodiments, a linear slide (not shown) can allow the vacuum chucks 1120a, 1120b to be actuated while the vacuum chucks 1120a, 1120b are advancing. The length of the motion of the vacuum chucks 1120a, 1120b along the webs 1149 can allow enough time for a measurement device (not shown) to measure the position of the first web 1149a and the second web 1149b, such that the vacuum chucks 1120a, 1120b can be adjusted to the proper alignment. In some embodiments, the machine vision system 1124a can include a camera to examine the relative position of the first web 1149a to the second web 1149b and compute the distance the pallet 1142 should move in the X-direction and/or the Y-direction.

As shown in FIG. 25, the first subassembly 1110a (and similarly, the second subassembly 1110b) includes a vacuum line 1129a that extends in the X-direction that is fluidly coupled to each of the first vacuum chucks 1120a via a vacuum transfer coupling 1134a. The transfer coupling 1134a can include a piston and provide vacuum access to the vacuum chucks 1120a, 1120b. The piston in the transfer coupling 1134a can include a slot that keeps the transfer coupling 1134a in fluidic contact with the vacuum line 1129a as the transfer coupling 1134a moves laterally. The web alignment assembly 1110 utilizes conveyor-like motion to bring the vacuum chucks 1120a, 1120b into contact with the webs 1149. The alignment in the X- and Y-directions occurs with precision at a high speed, while employing continuous motion tooling to broaden the time periods, over which events can occur.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
transferring a first semi-solid electrode material in a first direction into a chamber;
rotating the chamber about a central axis in a direction orthogonal to the first direction;
dispensing the first semi-solid electrode material in a second direction from the chamber onto a current collector in contact with a drum, the second direction opposite the first direction; and
coupling the first semi-solid electrode material and a second electrode material to a separator.

2. The method of claim 1, wherein rotating the chamber about the central axis is to an angle between about 160° and about 200°.

3. The method of claim 1, wherein transferring the first semi-solid electrode material in the first direction is from a pug mill.

4. The method of claim 1, further comprising:
rotating the drum while dispensing the first semi-solid electrode material onto the current collector.

5. The method of claim 1, wherein dispensing the first semi-solid electrode material onto the current collector is via an actuator in physical contact with the semi-solid electrode material.

6. The method of claim 1, further comprising:
applying a vacuum to the drum to reinforce a coupling between the current collector and the drum.

7. The method of claim 1, wherein the current collector is a first current collector, the method further comprising:
dispensing the second electrode material onto a second current collector.

8. The method of claim 7, further comprising:
enveloping the first electrode material, the first current collector, the second electrode material, the second current collector, and the separator in a pouch material.

9. The method of claim 8, further comprising:
conveying the enveloped materials as a web; and
sealing portions of the web to form an electrochemical cell.

10. A method comprising:
conveying a web around an outside surface of a drum, the web including anode materials, cathode materials, and separator material disposed therein;
rotating a sealing device relative to the drum to align the sealing device with a sealing position on the web;
moving a plurality of air cylinders toward the outside surface of the drum and into contact with the web such that the web is disposed between the air cylinders and the drum; and
dispensing air from the sealing device to the plurality of air cylinders to apply pressure to the web to form a plurality of individual electrochemical cells.

11. The method of claim 10, wherein the sealing device moves along a tracking path integrated into a structure housing the drum.

12. The method of claim 11, wherein sealing device moves between a top position in the tracking path and a bottom position in the tracking path via cams in the drum.

13. The method of claim 10, wherein moving the plurality of air cylinders toward the outside surface of the drum is perpetuated via axial movement of a guiding plate contacting the plurality of air cylinders.

14. The method of claim 10, wherein rotating the sealing device relative to the drum is via movement of an arm connected to the sealing device and the drum.

15. The method of claim 14, wherein the arm includes a first portion and a second portion having a common connection point and a variable angle between the first portion and the second portion of the arm.

16. The method of claim 15, wherein the first portion of the arm is coupled to the drum at a first connection point and the second portion of the arm is coupled to the sealing device at a second connection point.

17. The method of claim 16, wherein a first imaginary line extends from a central axis of the drum to the first connection point and a second imaginary line extends from the central axis of the drum to the second connection point, the first imaginary line and the second imaginary line forming a first angle when the sealing device is in a top position of a tracking path integrated into a structure housing the drum, the first imaginary line and the second imaginary line forming a second angle when the sealing device is in a bottom position of the tracking path, the second angle larger than the first angle.

18. A method, comprising:
advancing a web between a top conveyor and a bottom conveyor, the web including anode materials, cathode materials, and separator material disposed therein, the top conveyor and the bottom conveyor each including a plurality of vacuum chucks;
aligning a vacuum chuck from the top conveyor with a vacuum chuck from the bottom conveyor; and
sealing sections of the web via the vacuum chucks to form a plurality of electrochemical cells.

19. The method of claim 18, further comprising:
inducing rotational motion in at least one of the top conveyor or the bottom conveyor via a servo motor.

20. The method of claim 18, further comprising:
adjusting, via a bearing, an x-direction position of at least one of the vacuum chucks.

21. The method of claim 18, further comprising:
adjusting, via a bearing, a z-direction position of at least one of the vacuum chucks.

22. The method of claim 21, wherein the adjusting prevents chordal action of the vacuum chucks from striking the web as the web advances between the top conveyor and the bottom conveyor.

23. The method of claim 18, wherein the web is a first web, the method further comprising:
advancing a second web between the top conveyor and the bottom conveyor.

24. The method of claim 23, further comprising:
examining the relative position of the first web to the second web via a vision system.
